(19) United States
(12) Patent Application Publication
(10) Pub. No.: US 2024/0169417 A1
(43) Pub. Date: May 23, 2024

(54) MULTI-LAYERED DISPLAY

(71) Applicants: Jeffrey Mark Schuppe, Inver Grove Heights, MN (US); Austin Gray Odom, St. Paul, MN (US); Michael Paul Wood, Burnsville, MN (US)

(72) Inventors: Jeffrey Mark Schuppe, Inver Grove Heights, MN (US); Austin Gray Odom, St. Paul, MN (US); Michael Paul Wood, Burnsville, MN (US)

(21) Appl. No.: 17/993,672

(22) Filed: Nov. 23, 2022

(51) Int. Cl. G06Q 30/0601; G06Q 20/36; H04N 13/268; H04N 13/395

(52) U.S. Cl. CPC G06Q 30/0643; G06Q 20/36; H04N 13/268; H04N 13/395

(57) ABSTRACT

In general, this application is directed to a multi-layered display. One aspect is a method for producing a multi-layered display, the method comprising receiving an order for a multi-layered display, the order including an identifier for a non-fungible token (NFT), retrieving a digital file associated with the NFT, generating a multi-layered image from the digital file associated with the NFT, applying the multi-layered image on two or more panels, and producing the multi-layered display with the two or more panels. Another aspect is a multi-layered display comprising a light source, two or more panels including a multi-layered image generated from a digital file associated with an NFT, and a controller comprising a processor, a communication device, and a memory, wherein the controller is configured to control the light source via commands received at the communication device, wherein the one or more panels are aligned with the light source.

### BACKGROUND

The use of Non-Fungible Tokens (NFTs) to verify digital files is becoming increasingly popular. Each NFT includes a unique cryptographic entry on a distributed ledger, such as a blockchain. In typical examples, the NFT includes a smart contract which can be used to verify a digital file. In many examples, the digital file includes digital artistic content. The digital artistic content can be in many different formats including images, video, GIFs, virtual models, etc. Users may wish to showcase digital artistic content associated with an NFT in virtual and/or physical environments.

Artistic content can be displayed on many different mediums. Example mediums include paintings, drawings, printed images, sculptures, digital displays, collages, architecture, written content, audio output, video output etc. Some mediums may be preferred for displaying 3D characteristics of the artistic content.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

In general this application is directed to a multi-layered display. In some embodiments, systems and methods for producing a multi-layered display are disclosed. In some embodiments, the multi-layered display includes a multi-layered image generated from a digital file associated with a non-fungible token.

One aspect is a method for producing a multi-layered display, the method comprising receiving an order for a multi-layered display, the order including an identifier for a non-fungible token, retrieving a digital file associated with the non-fungible token, generating a multi-layered image from the digital file associated with the non-fungible token, applying the multi-layered image on two or more panels, and producing the multi-layered display with the two or more panels.

Another aspect is a multi-layered display comprising a light source, two or more panels including a multi-layered image generated from a digital file associated with a non-fungible token, and a controller comprising a processor, a communication device, and a memory, wherein the controller is configured to control the light source via commands received at the communication device, wherein the one or more panels are aligned with the light source.

Yet another aspect is a producer web server, comprising a network interface device, at least one processor, at least one memory device storing instructions which, when executed causes the producer webserver to provide a shopping user interface to a customer user computing device in response to receiving a request from the customer user computing device, receive an order for a multi-layered display from the customer user computing device, the order including an identifier for a non-fungible token, and generating a multi-layered image from a digital file associated with the non-fungible token, wherein the multi-layered display is produced by applying the multi-layered image on two or more panels.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates an example environment for ordering and producing a multi-layered display.

FIG. 2 illustrates an example method for producing a multi-layered display.

FIG. 3 illustrates an example system for ordering a multi-layered display.

FIG. 4 illustrates an example method for receiving an order for a multi-layered display.

FIG. 5 illustrates an example system for verifying a customer's rights for a non-fungible token (NFT).

FIG. 6 illustrates an example method for verifying a customer's rights for an NFT.

FIG. 7 illustrates a schematic diagram of an example producer webserver

FIG. 8 illustrates an example method for generating a multi-layered image.

FIG. 9 illustrates an example multi-layered display.

FIG. 10 illustrates an exploded view of a multi-layered display.

FIG. 11A illustrates a first panel of a multi-layered display.

FIG. 11B illustrates a second panel of a multi-layered display.

FIG. 11C illustrates a third panel of a multi-layered display.

FIG. 11D illustrates a fourth panel of a multi-layered display.

FIG. 11E illustrates a fifth panel of a multi-layered display.

FIG. 12 illustrates a perspective view of a multi-layered display.

FIG. 13 illustrates the example multi-layered display of FIG. 12 from a front side view.

FIG. 14 illustrates the example multi-layered display of FIG. 12 from a rear side view.

FIG. 15 illustrates the example multi-layered display of FIG. 12 from a right side view.

FIG. 16 illustrates the example multi-layered display of FIG. 12 from a left side view.

FIG. 17 illustrates the example multi-layered display of FIG. 12 from a top side view.

FIG. 18 illustrates the example multi-layered display of FIG. 12 from a bottom side view.

FIG. 19 illustrates an example multi-layered display.

FIG. 20 illustrates an example of a light box of a multi-layered display.

FIG. 21 illustrates a schematic diagram of an example controller for a multi-layered display.

FIG. 22 illustrates a controller mounted to the light box of a multi-layered display.

FIG. 23 illustrates a cross section view of an example multi-layered display.

FIG. 24 illustrates another cross section view of an example multi-layered display.

FIG. 25A illustrates an example of a deconstructed box of a multi-layered display.

FIG. 25B illustrates a semi-constructed multi-layered display.

FIG. 26 illustrates a perspective view of a multi-layered display.

FIG. 27 illustrates the example multi-layered display of FIG. 26 from a front side view.

FIG. 28 illustrates the example multi-layered display of FIG. 26 from a rear side view.

FIG. 29 illustrates the example multi-layered display of FIG. 26 from a right side view.

FIG. 30 illustrates the example multi-layered display of FIG. 26 from a left side view.

FIG. 31 illustrates the example multi-layered display of FIG. 26 from a top side view.

FIG. 32 illustrates the example multi-layered display of FIG. 26 from a bottom side view.

FIG. 33 illustrates the example multi-layered display of FIG. 26 from a cross section view.

FIG. 34 illustrates an example multi-layered display.

FIG. 35 illustrates an example of a multi-layered display in an augmented reality (AR) environment.

FIG. 36 illustrates an example of a multi-layered display in a virtual reality (VR) environment.

FIG. 37 illustrates an example of a user interface displaying supplemental NFT information in AR.

FIG. 38 is a block diagram illustrating an example of the physical components of a computing device.

### DETAILED DESCRIPTION

Various embodiments of the present disclosure will be described in detail with reference to the drawings, wherein like reference numerals represent like parts and assemblies throughout the several views. Additionally, any examples set forth in this specification are not intended to be limiting and merely set forth some of many possible embodiments.

In general this application is directed to a multi-layered display. In some embodiments, systems and methods for producing a multi-layered display are disclosed. In some embodiments, the multi-layered display includes a multi-layered image generated from a digital file associated with a non-fungible token (NFT).

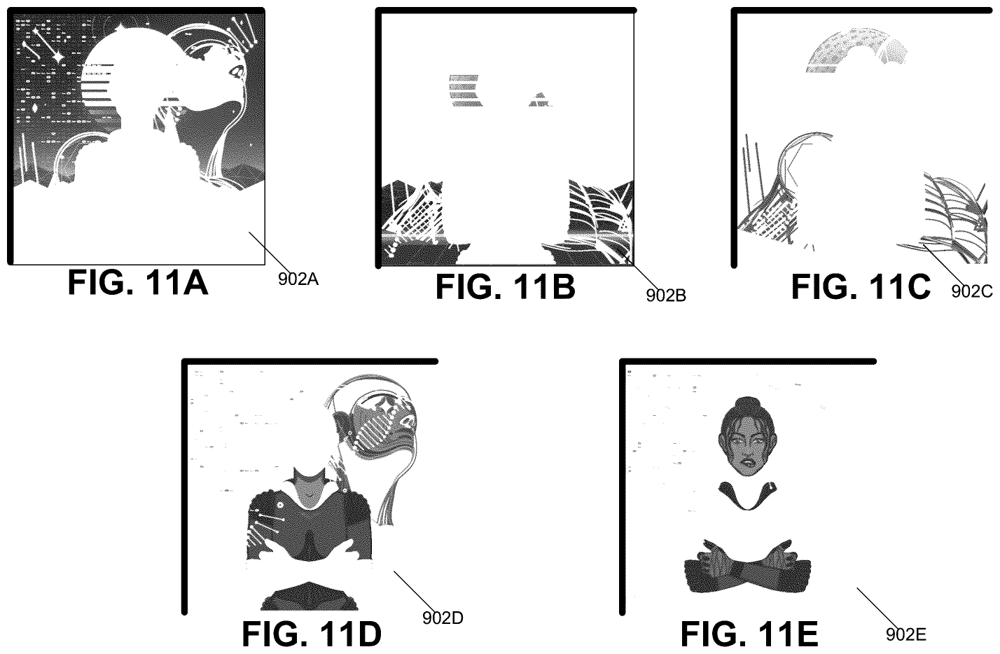

The multi-layered display typically comprises two or more panels. The panels, when correctly aligned create a multi-layered image with portions of the image displayed on different panels to provide depth to the image. Each panel is typically made from a translucent or semi-translucent material. The multi-layered image is transposed across the panels to re-create the image with depth. For example, parts of the image are applied to each panel, where the different parts applied to each of the different panels are visible at corresponding depths. An example, a multi-layered image transposed across a plurality of panels is illustrated and described in reference to FIGS. 11A-11E.

Although many of the embodiments disclosed herein include to content related to NFTs, similar methods and systems can be used to create multi-layered displays for content that is not associated with an NFT.

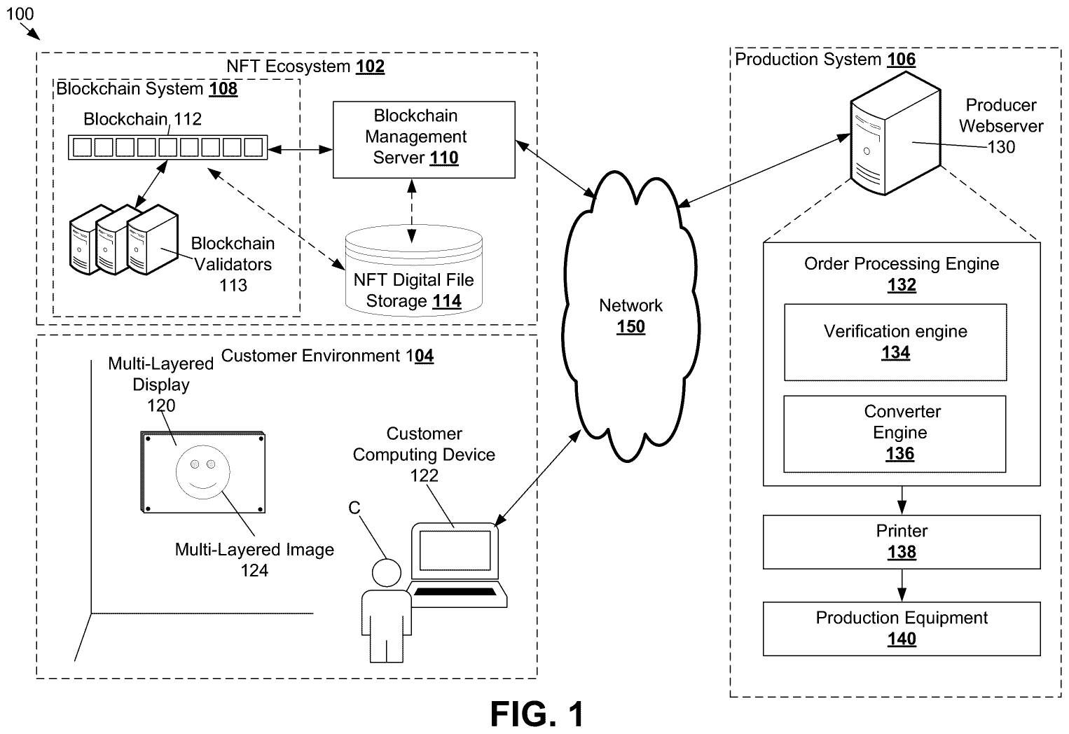

FIG. 1 illustrates an example environment 100 for ordering and producing a multi-layered display 120. The environment 100 includes an NFT ecosystem 102, a customer environment 104, and a production system 106. The NFT ecosystem 102 includes a blockchain system 108, a blockchain management server 110, blockchain validators 113, and an NFT digital file storage 114. The production system 106 includes a producer webserver 130, printer 138, and production equipment 140. The producer webserver 130 operates an order processing engine 132 with a verification engine 134 and a converter engine 136. The customer environment includes a customer computing device 122 operated by a customer user C. Also shown in the customer Environment 104 is a multi-layered display 120 presented a multi-layered image 124.

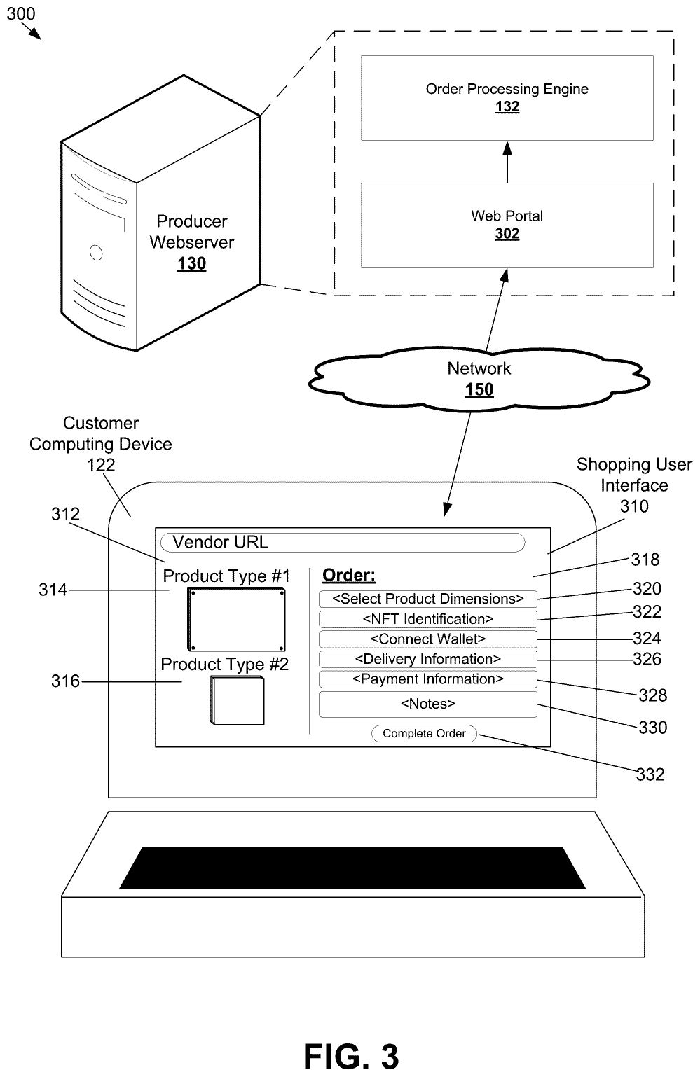

The customer user C operates the customer computing device 122 to receive a shopping user interface (UI). The customer can provide inputs on the shopping UI selecting an order or a multi-layered display. The order is provided to the producer webserver over the network 150. An example system for ordering a multi-layered display is illustrated and described in reference to FIG. 3. After the order is submitted and processed the multi-layered display 120 is produced and delivered to the customer environment 104. In some embodiments, the customer user C is an NFT creator who creates and provides a multi-layered image to the producer web-server. An identifier for the layered image, related digital file, and/or serial number for the physical product may be encrypted and stored on the blockchain once the creator mints the NFT. The multi-layered display 120 presents a multi-layered image 124. Examples, of the multi-layered display 120 are described herein.

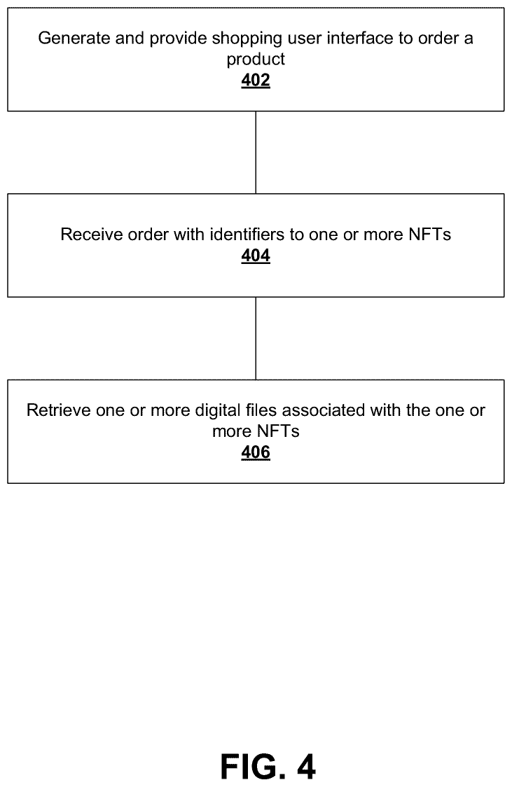

In some embodiments, the producer webserver is part of a production system 106. The producer webserver receives an order for a multi-layered display from the customer computing device 122. An example method for receiving an order for a multi-layered display (e.g., at the producer webserver 130) is illustrated and described in reference to FIG. 4.

The order is processed by the order processing engine 132. In some embodiments, the order processing engine 132 includes a verification engine 134 and a converter engine 136. In some embodiments, the order processing engine 132 also process the delivery information and/or payment information for the customer user C. Further examples of the order processing engine 132 are disclosed herein.

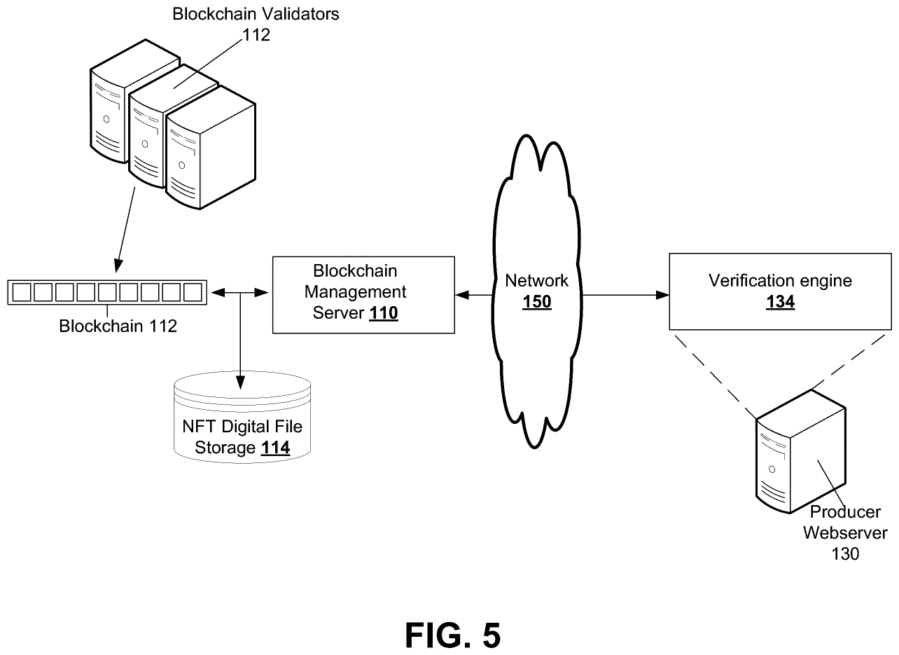

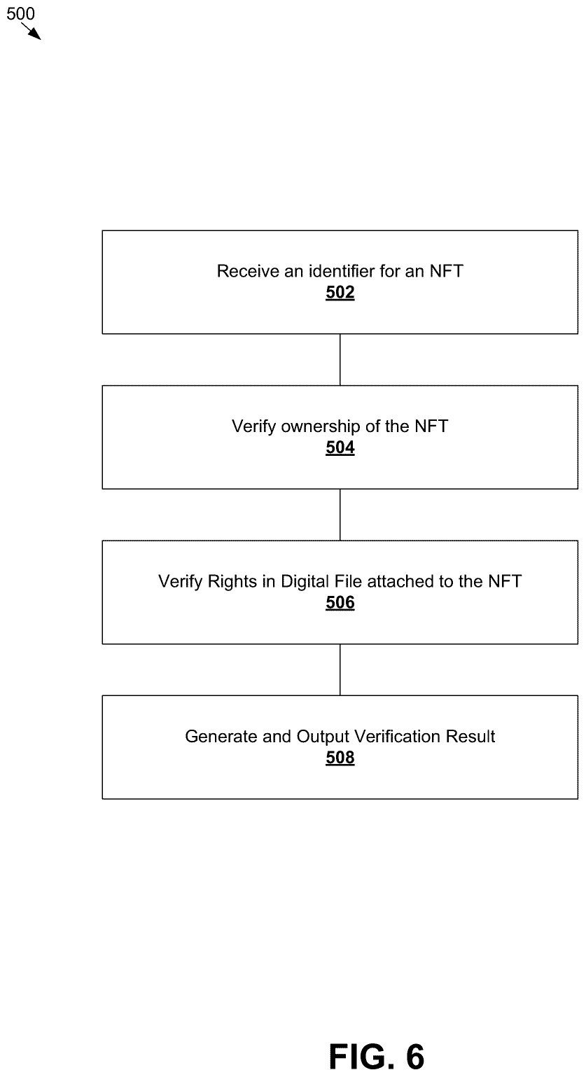

In some embodiments, processing the order includes verifying the NFT by the verification engine 134. In some embodiments, verifying the NFT includes verifying ownership of the NFT and/or verifying rights to use the digital file associated with the NFT. An example system for verifying a customer user's rights for an NFT is illustrated and described in reference to FIG. 5. An example method for verifying a customer user's rights for an NFT is illustrated and described in reference to FIG. 6. In some embodiments, verifying a customer users rights for an NFT includes directly or indirectly (e.g., via the blockchain management server 110) accessing the blockchain 112 at the NFT ecosystem 102.

In some embodiments, processing the order, by the order processing engine 132, includes retrieving a digital file associated with the NFT (e.g., from the blockchain management server 110 and/or the NFT digital file storage 114). After the digital file is received, the converter engine 136 converts the digital file into a multi-layered image. Examples of the converter engine are described herein.

The multi-layered image output but the converter engine 136 is applied on two or more panels via the printer 138. In some embodiments, the printer 138 directly applies the multi-layered image to the two or more panels. In some embodiments, the printer 138 uses a second surface printing technique, that prints the image backwards on the backside of the panel (either directly or indirectly with another material), such that the image appears in the correct direction from the front side. In some embodiments, the printer 138 prints the multi-layered image on a material that is applied to the two or more panels. For example, the printer 138 is configured to print on an adhesive which is applied to the two or more panels or the material output from the printer may be laminated to create the two or more panels. Other methods for applying a multi-layered image to produce two or more panels displaying the multi-layered image can also be used.

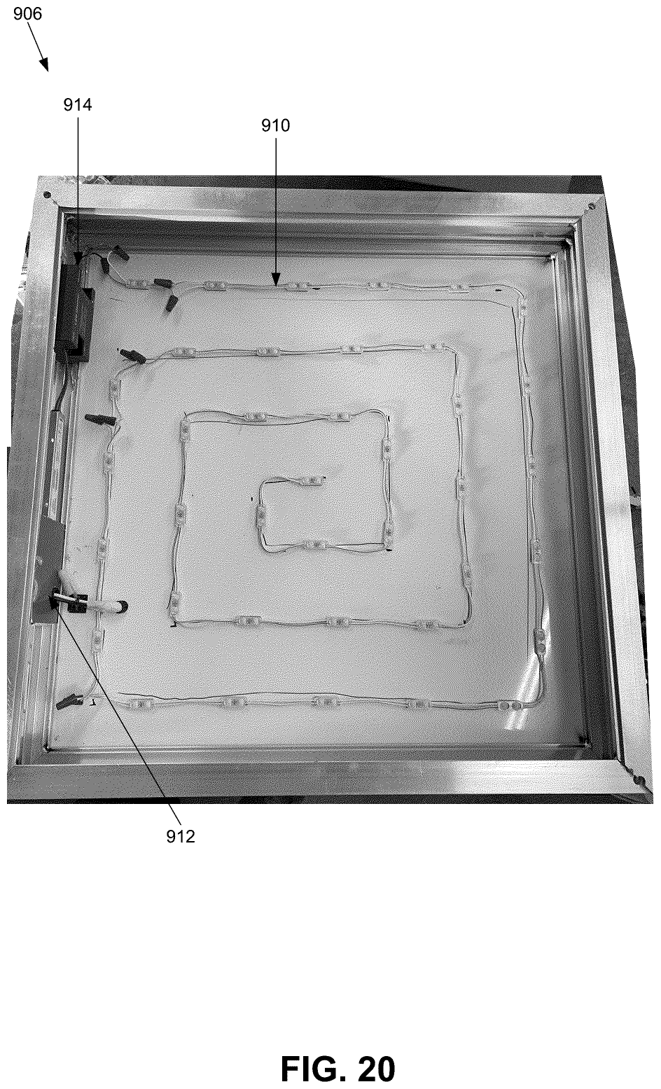

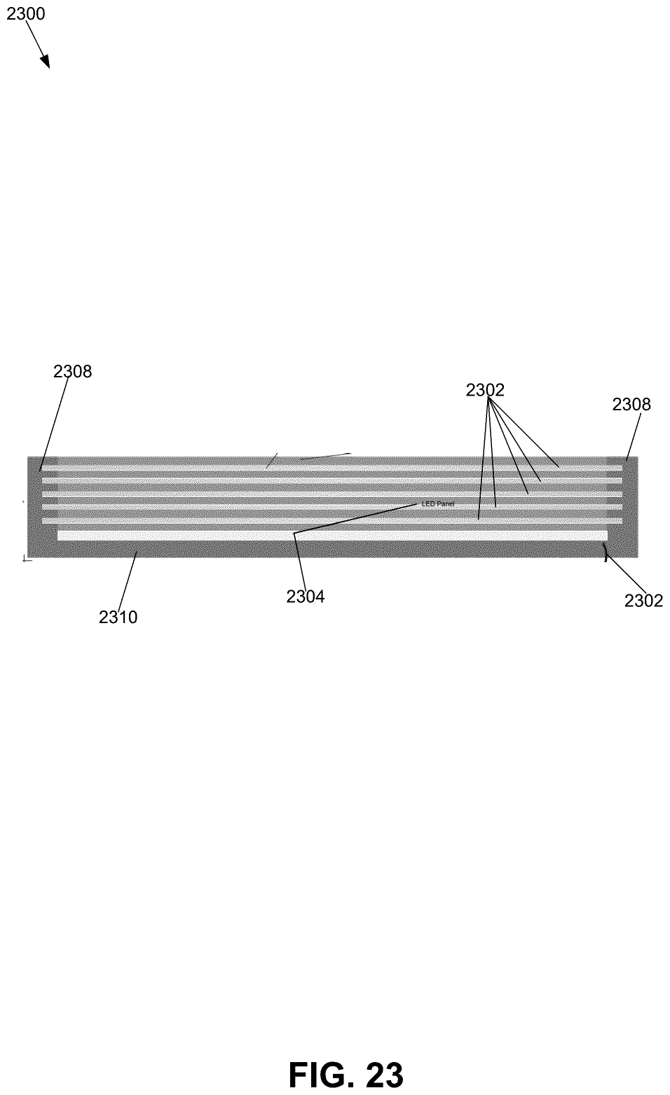

The production equipment 140 is used to construction the multi-layered display 120. In some embodiments, the two or more panels are aligned and connected or otherwise mounted to maintain alignment. In some embodiments, two or more panels are mounted on light source. In some embodiments, the light source is a light box. An example a lightbox is shown in FIG. 20. In other embodiments, the light source is an LED panel. For example, as shown in FIG. 23. Examples, of the components used for producing the multi-layered display are disclosed herein.

In some embodiments, the printer 138 prints several panels on a single sheet of material which is then cut with a router to form the two or more panels. For example, a single four by eight foot sheet of material could have four panels of the multi-layered display printed at the same time. The four by eight foot sheet can then be cut with a router (e.g., included as part of the production equipment 140). In some embodiments, a laminate is applied to the sheet first and then a router is used to cut the large panel into the two or more panels. In some embodiments, holes for mounting the panel (e.g., hoes to allow a rod to pass through the panel) are cut before applying the laminate or printing on the large panel.

In the embodiment shown, the NFT ecosystem 102 includes a blockchain system 108, a blockchain management server 110, and an NFT digital file storage 114. Other configurations are also possible. In some embodiments, the NFT ecosystem may include a public protocol for interfacing and maintaining the blockchain 112.

In some embodiments, the blockchain system 108 includes a blockchain 112 and blockchain validators 113. The blockchain 112 is maintained by the blockchain validators 113. In some embodiments, the blockchain 112 is a distributed ledger. In some embodiments, the distributed ledger is tracked in in a distributed database that tracks a list of ordered records. In some embodiments, each block records transactions which cannot be altered without consensus of the blockchain validators 113.

In some embodiments, the blockchain validators 113 comprises a plurality of computing systems which maintain the blockchain 112. In some embodiments, the blockchain validators 113 “mine” each block recorded on the blockchain 112.

In some embodiments, the blockchain 112 includes a system with a plurality of blockchain validators 113 linked over the network 150 which records a digital ledger. In some embodiments, the blockchain validators 113 are linked in a peer-to-peer network. Alternative digital ledger systems can also be used. In some embodiments, the blockchain 112 is implemented with a platform technology. For example Ethereum is a decentralized platform for a blockchain. Another example includes Solana. Any platform for a blockchain can be used which allows for the operation of a transaction protocol (e.g., smart contract) for a digital file stored at the NFT digital file storage 114.

The blockchain management server 110 is a server which in some embodiments may provide services that allow the producer webserver 130 to access the blockchain 112. In some embodiments, the blockchain management server operates an NFT marketplace. Although only one blockchain management server 110 is shown, any number of blockchain management servers can exist in an NFT ecosystem including systems operated by one or more different entities and/or a decentralized blockchain management server 110.

As discussed above, in some embodiments, the blockchain management server 11 includes one or more digital asset market places including NFT market places such as OpenSea, Rarible, Bitsky, Sandmilk, NBA Top Shot Marketplace, etc. In some embodiments, the blockchain management server 110 is accessible by the producer webserver 130 and the customer computing device 122 via the network 150.

The NFT digital file storage 114 stores one or more digital files associated with an NFT. Although the term digital files is used herein, the same features can be implemented with other digital assets. The NFT digital file storage 114 can be a centralized or decentralized datastore system. The digital files can include files of different types including JEGs, PNGs, GIFs, MP4s, FVGs, WEBMs, WAV, OGG; CLBG, GTLF, as well as other file types.

The network 150 may be a public or private network which is capable of connecting the various computing systems and devices described herein. In typical embodiments, the network 150 is a public network, such as the internet.

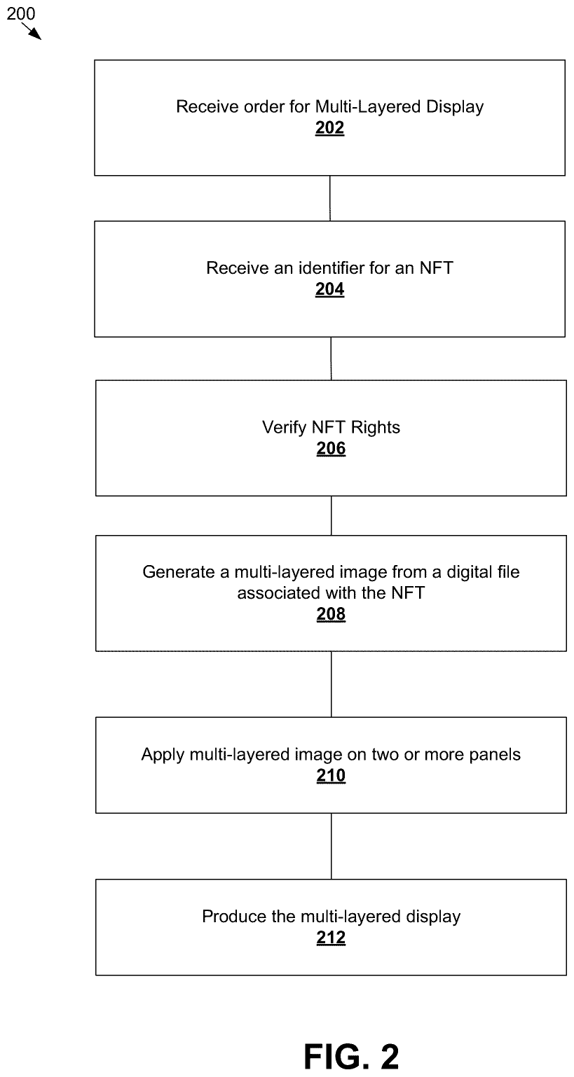

FIG. 2 illustrates an example method 200 for producing a multi-layered display. In some embodiments, the method 200 is performed at the production system 106 illustrated and described in reference to FIG. 1. The method 200 includes the operations 202, 204, 206, 208, 210, and 212.

The operation 202 receives an order for a multi-layered display. In some embodiments, the order is received from the customer computing device 122 as illustrated in FIGS. 1 and 3. In some embodiments, the order includes one or more of a selection of a multi-layered display type from a plurality of multi-layered display types, a dimensions selection, identifier for the NFT (in some embodiments, received at the operation 204), other digital file to present on the multi-layered display, customer delivery information, payment information, customer account information, customer notes or special requests etc. In some embodiments, the customer notes include suggestions or instructions for creating the multi-layered image.

The operation 204 receives an identifier for an NFT. In some embodiments, the identifier for the NFT is a link to an NFT exchange which lists the NFT. In some embodiments, the identifier for the NFT is the unique digital identifier recorded on the blockchain. In some embodiments, a user connects a wallet storing an NFT as part of the ordering process. In some embodiments, the method 200 does not include the operation 204. For example, a digital file not associated with an NFT is received (e.g., uploaded or linked to from the customer user device).

An example system for the operations 202 and 204 is illustrated and described in reference to FIG. 3. In some embodiments, the operations 202 and 204 are performed at the producer webserver 130 as illustrated and described in reference to FIG. 1.

The operation 206 verifies rights to use a digital file associated with the NFT. In some embodiments, the operation 206 checks whether the customer user has the correct rights to reproduce aspects of the digital file in a physical structure. In some embodiments, the operation 206 verifies the rights associated with the NFT including ownership of the NFT and/or rights to use the digital file associated with the NFT. An example system for verifying a customer user's rights for an NFT is illustrated and described in reference to FIG. 5. An example method for verifying a customer user's rights for an NFT is illustrated and described in reference to FIG. 6.

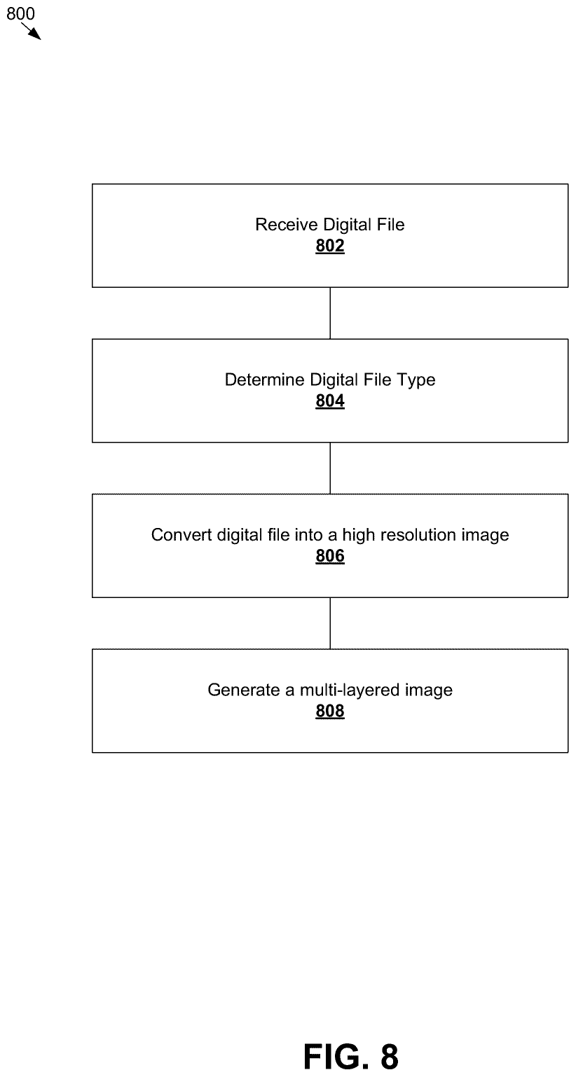

The operation 208 generates a multi-layered image from the digital file associated with the NFT. In some embodiments, generating the multi-layered image comprises receiving the digital file associated from the NFT. In some embodiments, the digital file is received from an NFT exchange. In some embodiments, the digital file is received via accessing the blockchain the NFT is recorded on and based on the entry on the blockchain determining how to access and retrieve the verified digital file. Next, the digital file is analyzed to determine a file type. For example, the digital file may comprise an image, 3D model, GIF, or video content. In some embodiments, the digital file is either an image or is converted to a digital image. For example, video or GIF content can be converted into image content by taking one or more snapshots or combining different images or features throughout the video content. Similarly, audio content can be converted into an image by taking a visual representation of an audio file. The image is converted into a high resolution image. In some embodiments, the image is converted to a vectorized 3D image. The high resolution image is then divided up into different panels based on features of the image. For example, background content may be determined and placed on a back layer, the subject of the image (e.g., character, landscape, etc.) may be identified and placed on a panel towards the front. IN some embodiments, special characteristics or features of emphasis are selected for the front most panel. An example of a multi-layered image displayed over five panels is illustrated and described in reference to FIGS. 11A-11E. An example method for generating a multi-layered image is illustrated and described in reference to FIG. 8. In some embodiments the multi-layered image is automatically generated. In some embodiments, at least some of the steps for generating the multi-layered image are preformed manually.

The operation 210 applies a multi-layered image on two or more panels. In some embodiments, the multi-layered image is printed on the two or more panels. In some embodiments, second surface printing is used (e.g., printing the image in reverse on the backside of the panel). In some embodiments, the multi-layered image is printed on an adhesive (e.g., a vinyl) that is applied to the panel. For example using a vinyl application equipment (rollers). In some embodiments, the multi-layered image is applied using a laminate. In some embodiments, the printer 138 shown in FIG. 1 is used to apply the multi-layered image to the two or more panels.

The operation 212 produces the multi-layered display. In some embodiments, the multi-layered display is produced using the production equipment 140 shown in FIG. 1. In some embodiments, the multi-layered display is automatically constructed using machinery and/or robotics. In some embodiments, at least some of the steps for producing the multi-layered display are performed manually.

FIG. 3 illustrates an example system 300 for ordering a multi-layered display. The system 300 includes a customer computing device 122 and a producer webserver 130. The producer web server includes a web portal 302 and an order processing engine 132.

The customer computing device 122 presents a shopping user interface 310. In some embodiments, the shopping user interface 310 is received from the web portal 302 in response to a request from the customer computing device 122.

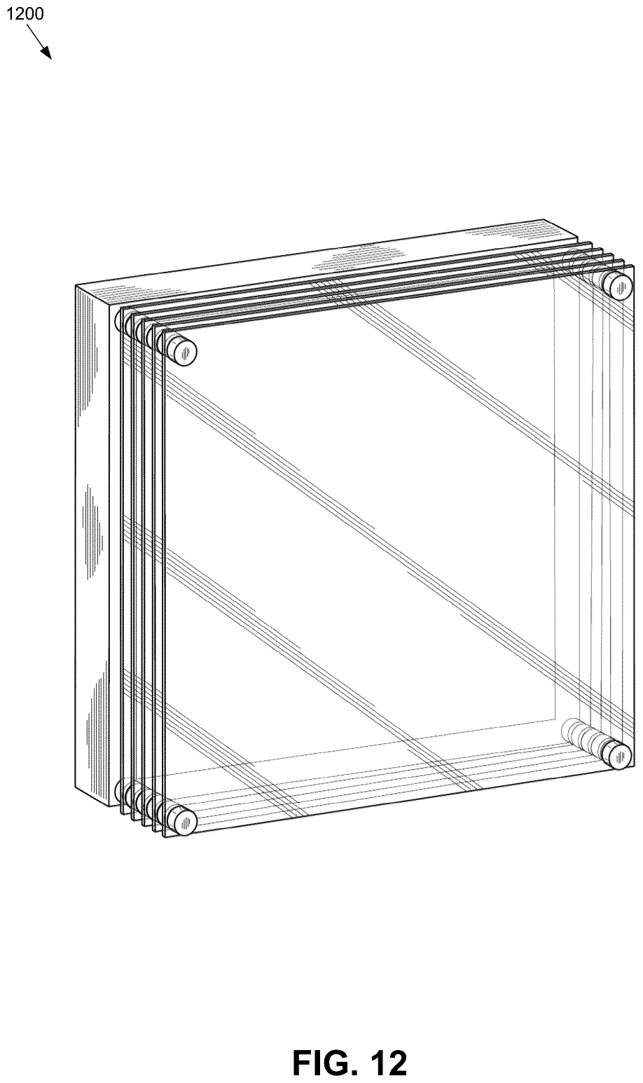

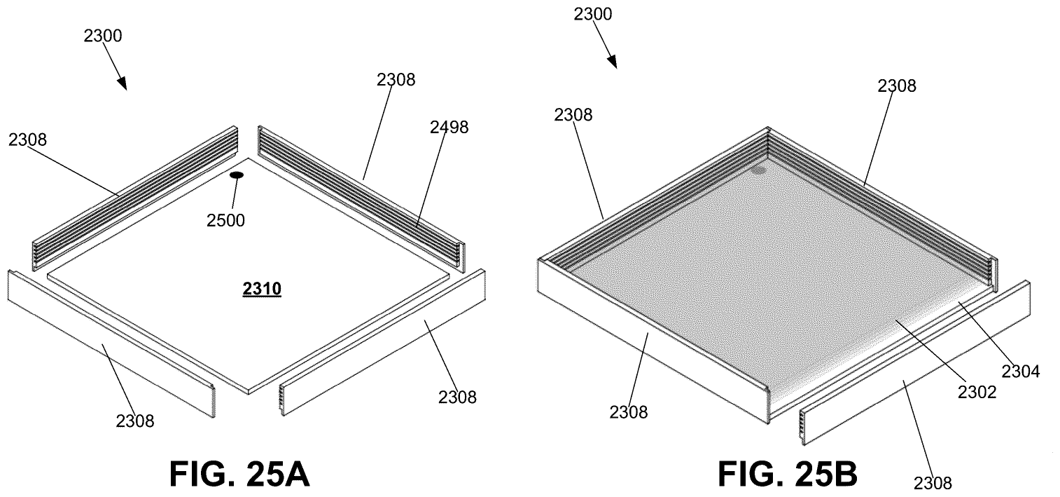

The shopping user interface 310 includes a multi-layered display product selector panel 312 for selecting a multi-layered display type. In the example shown, a user can select from a first product type 314 and a second product type 316. Many other multi-layered display types may exist and different user interfaces to display and select a product. In some embodiments, the first product type 314 corresponds to the multi-layered display illustrated and described in reference to FIGS. 12-18 and the second product type 316 corresponds to the multi-layered display illustrated and described in reference to FIGS. 25-32.

The shopping user interface 310 also includes an order selection panel 318. The order selection panel includes entries for order information. Order information can include any combination of product dimensions 320, identifier for an NFT 322, a connect wallet input 324, delivery information 326, payment information 328, and customer notes 330. Once a user completes an order the user can select the complete order button 332 and the order is sent over the network 150 to the web portal 302 of the producer web server. In some embodiments, the shape selected is based on the dimensions of the image in the digital file associated with the NFT.

FIG. 4 illustrates an example method 400 for receiving an order for a multi-layered display. In some embodiments, the method 400 is performed at the producer webserver 130, illustrated and described in reference to FIG. 1 and FIG. 3. The method 400 includes the operations 402, 404, and 406.

The operation 402 generates and provides a shopping user interface to order a product. In some embodiments the shopping user interface 310 shown in FIG. 3 is provided to the customer computing device 122. The operation 404 receives an order including an identifier for one or more NFTs. The operation 406 retrieves one or more digital files associated with the one or more NFTs. In some embodiments, a digital file not associated with an NFT is received.

FIG. 5 illustrates an example system 450 for verifying a customer's rights for an NFT. The system 450 includes a producer webserver 130 in communication with a blockchain management server via a network 150. The blockchain management server 110 is able to access the blockchain 112 to verify information related to an NFT and an NFT digital file storage 114 storing one or more digital files associated with the NFT. The blockchain is maintained by the blockchain validators 113.

In some embodiments, the verification engine 134 verifies ownership of the NFT. In some of these embodiments, the customer will provide a public wallet ID which includes an NFT ID. The verification engine can verify the NFT ID belongs to the wallet ID either directly on the blockchain 112 or using the blockchain management server 110. In some embodiments, once ownership is verified, the verification engine 134 checks if there are any restrictions on the digital file associated with the NFT. In some embodiments, such restrictions are stored on the blockchain as part of a smart contract. In some embodiments, the restrictions may be stored on a webpage associated with an NFT project. The verification system may operate directly with the blockchain or an NFT project's terms of service to determine what restrictions on the use of the digital image exist. In some embodiments a separate system or service is provided to verify the NFT. In some embodiments, a customer may have rights to create derivative works of a digital file without necessarily being the owner of the associated NFT. For example, some NFT projects may allow for the reproducing of content in derivative works. In some embodiments, the verification engine outputs a verification result based on whether the requesting customer user has rights to create a multi-layered image from the digital file associated with the NFT based on the rights determined for the associated digital file, and if required, ownership of the NFT.

FIG. 6 illustrates an example method 500 for verifying a customer's rights for an NFT. In some embodiments, the method 500 is performed on the system 450 shown in FIG. 5. The method 500 includes the operations 502, 504, 506, and 508.

The operation 502 receives an identifier for an NFT. The operation 504 verifies ownership of the NFT. In some embodiments, the operation 504 is optional or performed after the operation 506. For example, the operation 506 may determine which customer users have appropriate right in the associated digital file, such that determining ownership is not required. The operation 506 verifies rights in the digital file attached to the NFT. The operation 508 generates and outputs a verification result. The verification results indicates whether the requesting customer user is able to legally produce a multi-layered image based on the content in the associated digital file of the NFT.

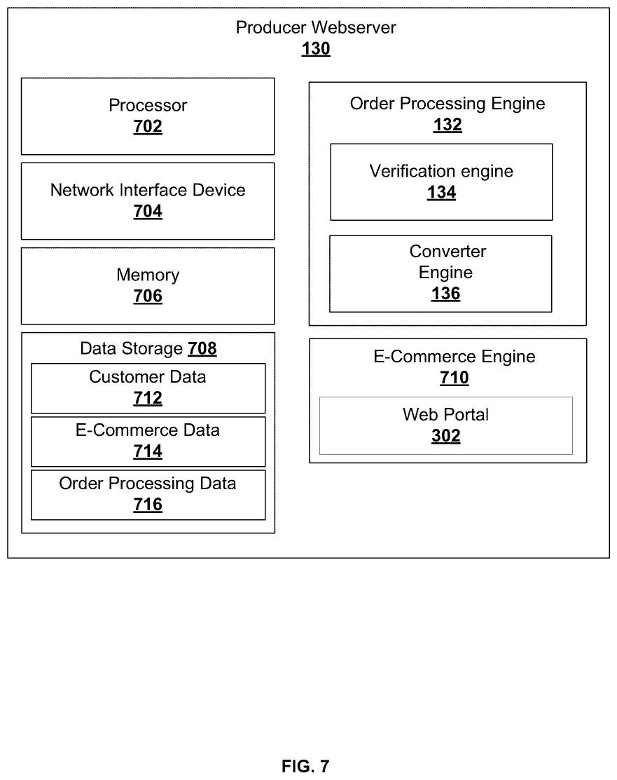

FIG. 7 illustrates a schematic diagram of an example producer webserver 130. The producer webserver 130 includes a processor 702, a network interface device 704, a memory 706, a data storage 708, an order processing engine 132 and an e-commerce engine 710.

The memory 706 stores instructions which, when executed by the processor 702, cause the producer webserver 130 to implement various features and functions including the order processing engine 132, verification engine 134, the converter engine 136, the e-commerce engine 710, and the web portal 302.

The network interface device 704 is configured to allow the producer webserver 130 to communicate with other computing devices to perform some of the operations disclosed herein.

The data storage 708 includes customer data 712, e-commerce data 714, and order processing data 716. The customer data 712 may include customer account, a public address for the customers NFT wallet, delivery address information, contact information etc. The e-commerce data 714 may include the data for presenting the e-commerce website including production information and product availability (e.g., inventory). The order processing data 716 may include data to verifying a customer's rights to create the multi-layered image with the desired content. The order processing data 716 may also temporarily store encrypted payment details for payment processing purposes.

The order processing engine 132 includes a verification engine 134 and a converter engine 136. The order processing engine 132 may further process delivery and payment information for orders received from customer users. In other embodiments, payment information and or delivery information is processed by the e-commerce engine. The order processing data may interface with the order processing data 716 stored at the data storage 708.

The verification engine 134 is used to verify that the requesting customer user has rights to create a multi-layered image from the content in the digital file associated with the NFT. An example system 498 for verifying a customer's rights for a non-fungible token is illustrated in FIG. 5 and an example method 600 for verifying an NFT is illustrated and described in reference to FIG. 6.

The converter engine 136 receives a digital file and transforms the content in the digital file into a multi-layered image. An example method for converting a digital file into a multi-layered image is illustrated and described in reference to FIG. 8. The operation 208 shown in FIG. 2 is an example operation for generating a multi-layered image from the digital file associated with the NFT. In some embodiments, the operation 208 shown in FIG. 2 is executed by the converter engine 136.

The e-commerce engine 710 operates to perform the e-commerce functions described herein. For example, the e-commerce engine 710 can generate and provide the shopping user interface to customer users via the web portal 302 and the network interface device 704. The e-commerce engine may interface with the customer data 712 and e-commerce data 714, stored at the data storage 708, to track customer accounts, order histories, etc.

FIG. 8 illustrates an example method 800 for generating a multi-layered image. In some embodiments, the method 800 is performed automatically at the converter engine 136 as shown in FIG. 7. In some embodiments, at least some of the operations in the method 800 are performed manually at a computing device with an application configured to receive user inputs for creating and/or modifying a multi-layered image. In some embodiments, the method 800 is example method for performing the operation 208 shown in FIG. 2. The method 800 includes the operations 802, 804, 806, and 808.

The operation 802 receives a digital file. In some embodiments, the digital file is associated with an NFT. In other embodiments, the digital file is not associated with an NFT. In some embodiments, the operation 802 receives the digital file based on an identifier for the digital file. For example, the operation 802 can query the correct data based to retrieve the digital file.

The operation 804 determines a digital file type. The operation 806 converts the digital file into a high resolution image. In some embodiments, the operation 806 converts the digital file into a high resolution image (e.g., a vectorized image) based on the file type determined at the operation 804. For example, if the digital file is a type of a video content, then an algorithm or manually inputs received at a user interface are used to select one or more portions of the video content to create an image. Similarly, if the content is audio content the operation 806 may convert the audio file into a visual representation of the audio file, etc. These images are then converted into a high resolution image. In some embodiments, the high resolution image is a 3D vectorized image. If the file type is of a 3D image or model, then the 3D features may be transposed to be represented in the multi-layered image. In many typical embodiments, the digital file type is a 2D image which is converted into the high resolution image. In some embodiments, the digital file includes an image in a low resolution. In some of these embodiments converting the digital file to a vectorize image at the operation 804 includes improving the resolution of the image.

The operation 808 generates the multi-layered image. The multi-layered image may automatically be generated using an artificial intelligence algorithm. In some embodiments, a machine vision algorithm is used to detect background features to place on panels further to the back main subject matter features to place near the front and significant features to place on the front most panel. In some embodiments, a machine vision algorithm is used to detect objects in the image, where 3D models of the same object are analyzed to provide 3D data which is then represented in the multi-layered image. In some embodiments, the operation 808 is performed manually by an expert using notes form the customers and/or by a customer user. In some examples, the multi-layered image is generated by cutting out portions of the image to place at each layer of the multi-layered image.

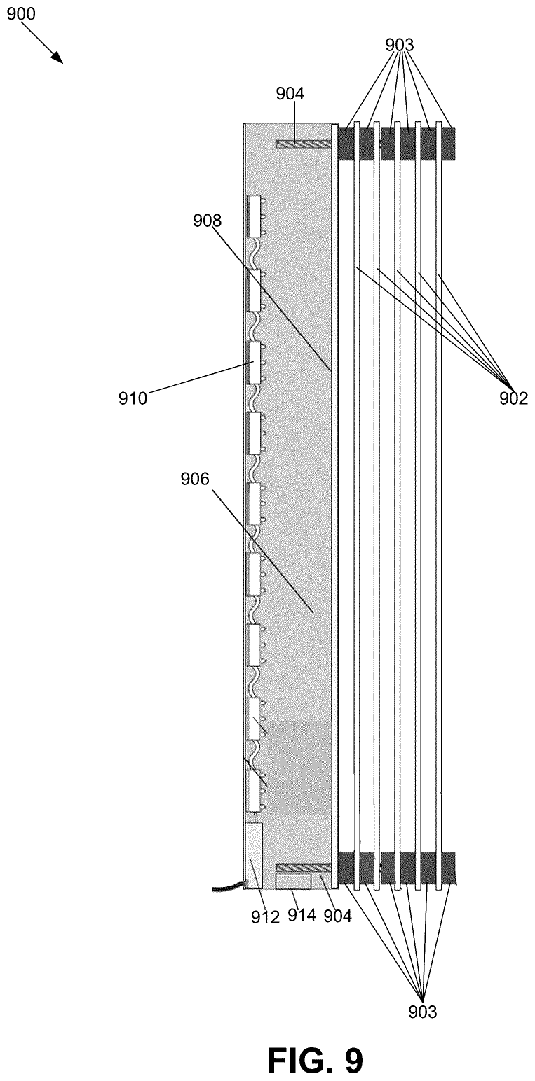

FIG. 9 illustrates an example multi-layered display 900. The multi-layered display 900 is an example of the multi-layered display 120 illustrated and described in reference to FIG. 1. FIG. 9 illustrates a cross-section view of the multi-layered display. In some examples, the multi-layered display is two feet by two feet. However, the multi-layered display can be of different dimensions and shapes. In some embodiments, the multi-layered display 900 is twenty four inches by twenty four inches by three inches. In some embodiments, the multi-layered display 900 includes a geo tag.

The multi-layered display 900 includes panels 902. The panels 902 can include two or more panels. In the example shown, the multi-layered display 900 includes five panels. However different embodiments may include two panels, three panels, four panels, five panels, six panels, etc. In some embodiments, each of the panels 902 are made of a clear material. Example materials include acrylic, glass, or polycarbonate material. Some embodiments include combinations thereof. The panels can be of many different dimensions and shapes. In some embodiments, the thickness of each panel is an eighth of an inch. However, the panels can be made of different thicknesses depending on the material and the dimensions of the panels.

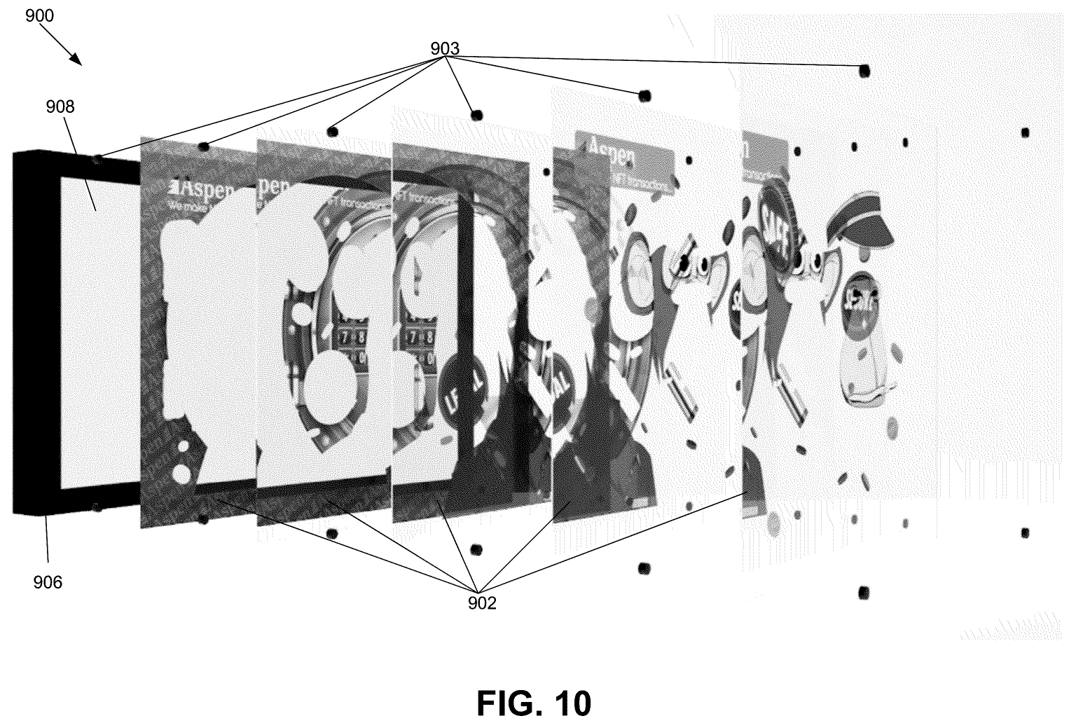

The two or more panels 902 are mounted to each other and the light box 906 by the rod 904. In some embodiments, the rod 904 is a threaded connector which connects the panels with the standoffs 903 placed between each panel to provide depth between the panels 902. In some embodiments, the rod 904 mounts the panels 902 and the standoffs 903 to the light box using a nut welded or installed on the interior side of the front of the light box 906. Although not shown, in FIG. 9, the multi-layered display 900 different number of rod 904 based on the size and shape of the multi-layered display. In examples where the multi-layered display is rectangular or square four shanks may be placed near each corner. For example, as shown in FIG. 10.

In some embodiments, the standoffs 903 are 1 inch in diameter. However, the standoffs can be of different sizes. In some embodiments, the sizes are based on the size of the panels 902. For example, bigger standoffs can be used when the multi-layered display is bigger. In some embodiments, the standoffs 903 are three eights of an inch thick. In some embodiments, the standoffs 903 are a quarter inch thick. Other thickness can also be used. In some embodiments, the standoffs 903 are made of a black material or are painted black.

The multi-layered display 900 includes a light box 906. The light box 906 includes a light source 910. The light source 910 may include one or more LED lights aligned on the inside of the backside of the light box 906. In the example, shown the light source 910 includes a plurality of individual lights connected in series. The light source 910 is arranged such that the light appears to fully illuminate the diffuser 908. The diffuser is typically a semi-translucent or opaque material which is configured to diffuse the light provided from the light source. In the example, shown the diffuser 908 forms a front side of the light box 906. An example of an interior view of the light box 906 illustrating an example arrangement of the light source 910 is illustrated and described in reference to FIG. 20. In some embodiments, the diffuser 908 is used to evenly light the front surface of the light box 906.

In some embodiments, the light box 906 is made a of metallic material. In some embodiments, the light box 906 is made from extruded aluminum. In some embodiments, the light box 906 is made from wood. In some embodiments, a customer user can select a type of material for the light box. In some embodiments, parts of the light box 906 are welled or mitered.

The light box 906 includes a power source 912. In some embodiments, the power source 912 includes a wired connect to a wall outlet. In some embodiments, the power source includes a battery. In some of these embodiments, the battery is rechargeable. In some embodiments, the battery is replaceable.

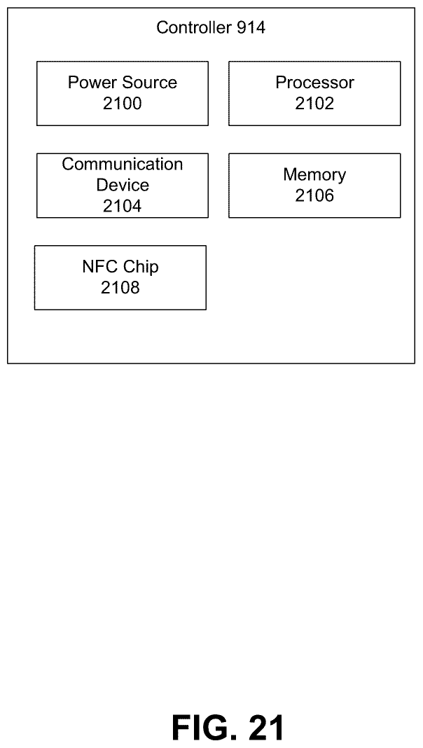

In some embodiments, the light box 906 includes a controller 914. The controller 914 may be used to receive signals to adjust the light emitted from the light source 910 (e.g., turn on/off the light, dim the light, etc.). In some embodiments, the controller 914 operates a timer for the light source. The controller may connect directly to a local network or a customer user computing device. A schematic diagram illustrating an example components for the controller 914 is illustrated and described in reference to FIG. 21 In some embodiments, the multi-layered display 900 includes physical inputs to turn on or off the light source and or to dim the light source. In some embodiments, the physical inputs are located on an exterior side of the light box 906.

In some embodiments, the multi-layered display 900 includes a wall mount to attach the multi-layered display 900 to a surface. In some embodiments, the wall mount is a french cleat. In other embodiments, a standard mount is used. For example, a mount used for a TV or monitor, etc.

FIG. 10 illustrates an exploded view of a multi-layered display 900 of FIG. 9. The exploded view includes the two or more panels 902 each separated at around each corner of the panel with the standoffs 903. The two or more panels 902 are aligned with the light box 906 and the standoffs 903 such that the rods (e.g., the rods 904 illustrated in FIG. 9 but not shown in FIG. 10) can mount the two or more panels 902 to the light box 906. Each panel of the two or more panels 902 includes a portion a layered image which when aligned creates a multi-layered image. The lightbox includes a diffuser 908 at least partially forming a front end of the light box 906.

FIGS. 11A-11E illustrates a panels 902A-E forming a multilayered image which when mounted create a of a multi-layered display. FIG. 11B illustrates a first panel 902A of a multi-layered display. In the example shown, the first panel 902A is the panel mounted closest to the back of the multi-layered display. FIG. 11B illustrates a second panel 902B of a multi-layered display, which is configured to be mounted in front of the first panel 902A to create the multi-layered image. FIG. 11C illustrates a third panel 902C of a multi-layered display, which is configured to be mounted in front of the second panel 902B. FIG. 11D illustrates a fourth panel 902D of a multi-layered display, which is configured to be mounted in front of the third panel 902C to create the multi-layered image. FIG. 11E illustrates a fifth panel 902E of a multi-layered display, which is configured to be mounted in front of the four panel 902D to create the multi-layered image. In some embodiments, the panels closer to the back of the multi-layered display (e.g., 902A, 902B, and 902C) contain portions of the image that are considered the background portions of the image, whereas the panels closer to the front contain the more significant subject matter of the image, with the most prominent features of the image on the front-most panel (e.g., 902E). However, other arrangements are also possible and within the scope of the disclosure in this application.

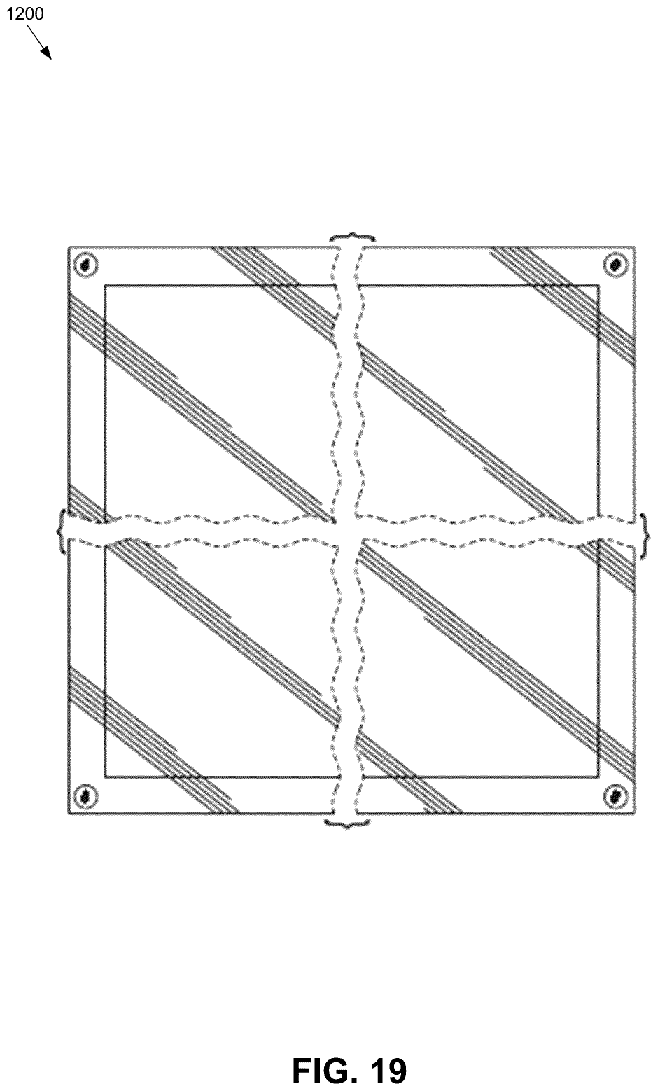

FIGS. 12 through 18 illustrate an example multi-layered display 1200 from different perspectives. FIG. 19 illustrates the example multi-layered display 1200 further exemplifying that the multi-layered display may be of different dimensions. Although the examples illustrated herein are in a rectangular or square shape, the multi-layered display can be of any shape including circular, oval, or the shape of an element in the multi-layered image (e.g., a shape of a character or environmental element, such as a tree or cloud). In some embodiments, the light box matches the shape of the multi-layered image. In other embodiments, the light box is a square or rectangle shape with the light blocked from the areas outside the boundaries of the shaped panels.

FIG. 12 illustrates a perspective view of a multi-layered display 1200. The multi-layered display 1200 comprises the same or similar components as the multi-layered display 900 illustrated and described in reference to FIGS. 9 and 10.

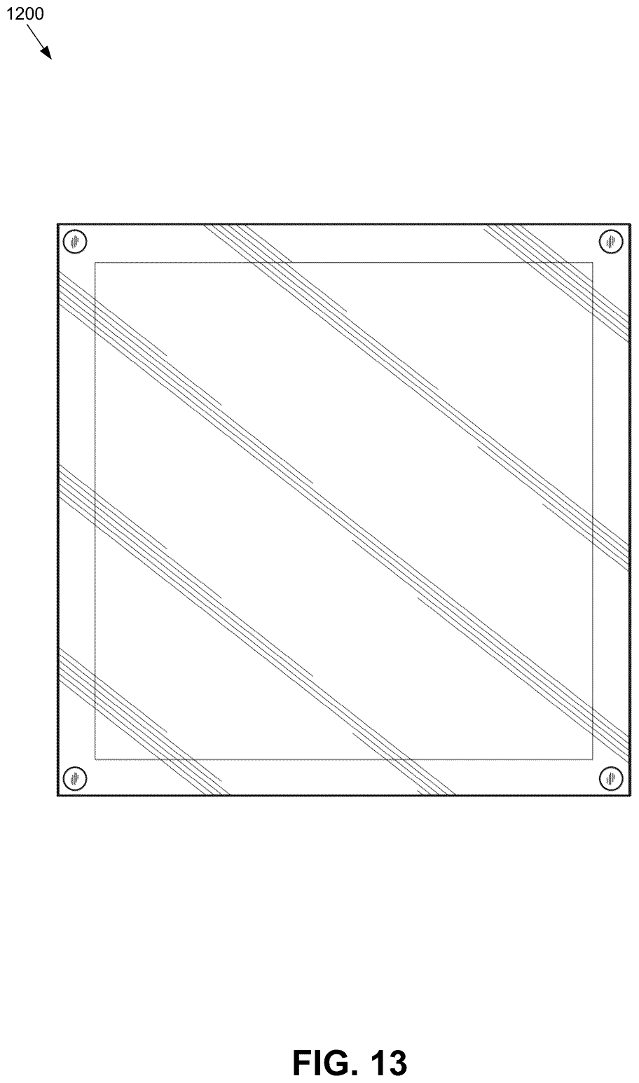

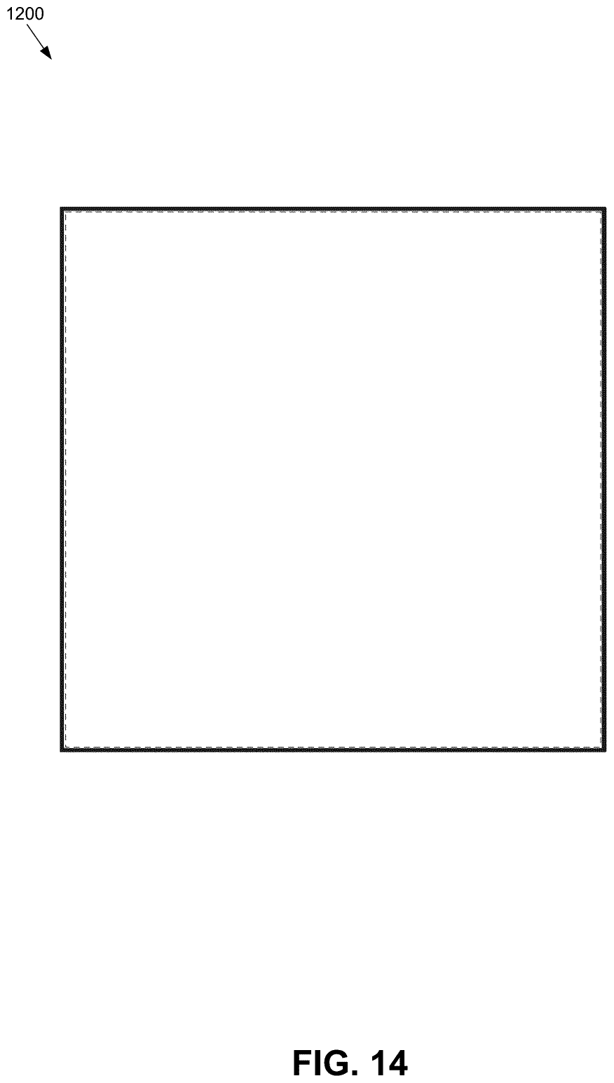

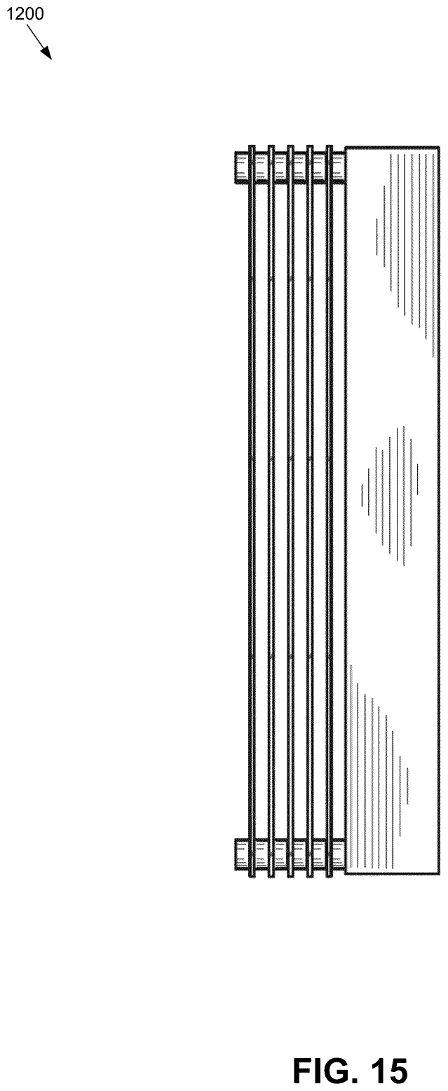

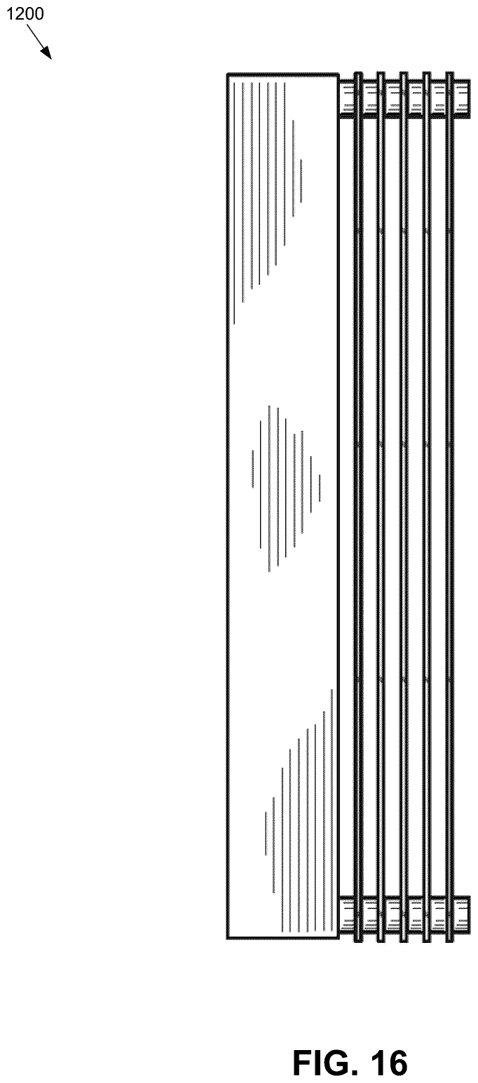

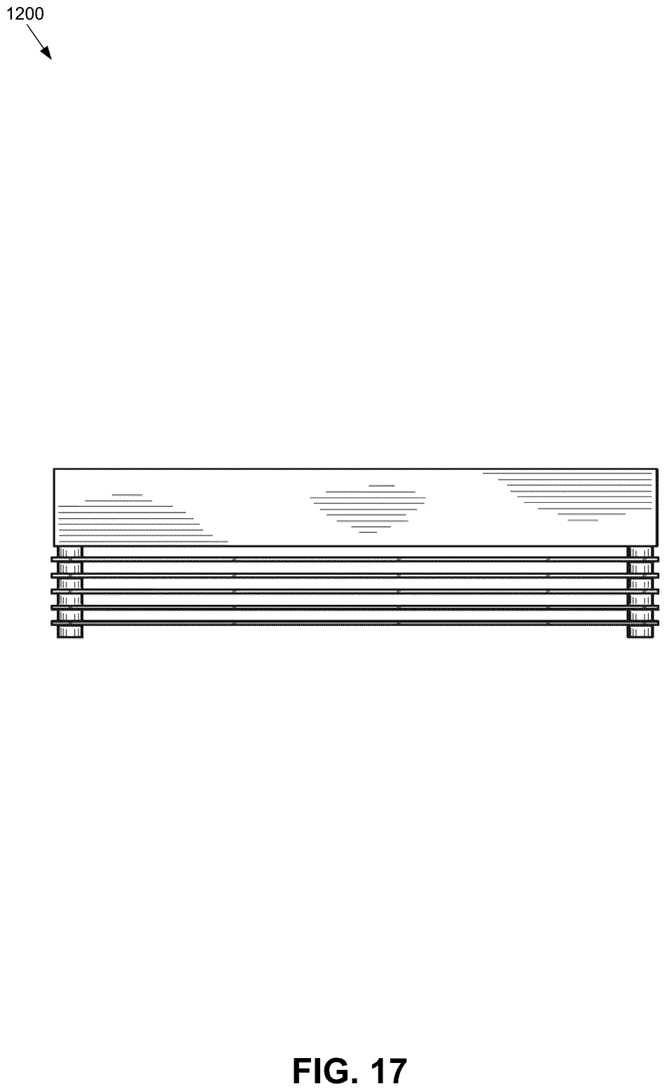

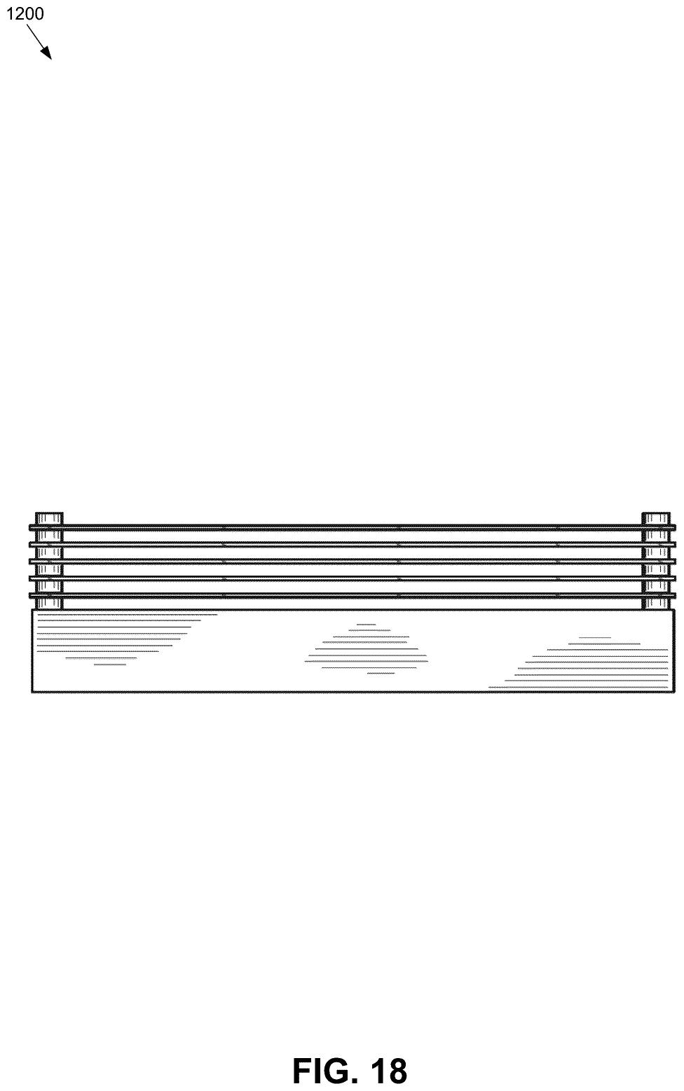

FIG. 13 illustrates the multi-layered display 1200 of FIG. 12 from a front side view. FIG. 14 illustrates the multi-layered display 1200 of FIG. 12 from a back side view. FIG. 15 illustrates the multi-layered display 1200 of FIG. 12 from a right side view. FIG. 16 illustrates the multi-layered display 1200 of FIG. 12 from a left side view. FIG. 17 illustrates the multi-layered display 1200 of FIG. 12 from a top side view. FIG. 18 illustrates the multi-layered display 1200 of FIG. 12 from a bottom side view.

FIG. 19 illustrates an example multi-layered display 1200. In the example of FIG. 19 the area represented between the dashed wavy lines are break lines and the are between these lines do not form the multi-layered display but instead provided to illustrate that the multi-layered display 1200 may be of a wide variety of different dimensions. As described above, the multi-layered display may be formed in many different shapes.

FIG. 20 illustrates an example of a light box 906 of a multi-layered display. The example shows the interior of the light box 906 without the diffuser (e.g., the diffuser 908 as shown in FIG. 9). The power source 912 and the controller 914 are mounted to a side wall of the light box 906, such that the power source 912 and controller 914 do not interfere with the light emitted from the light source 910. In some embodiments, the power source and/or the controller are covered with a material which reflects the light emitted towards the controller and/or power source. For example, the controller 914 and/or the power source 912 may be covered with a white vinyl, a white tape, reflective tape, other reflective covering, or may be made of a reflective material.

The light source 910 is arranged along the inside of the backside of the light box, such that the emitted light fully illuminates the diffuser when the diffuser is mounted on the front side of the light box 906. In the example shown, the light source 910 includes a plurality of LED lights installed in a series placed sufficiently close such that from the distance between the lights and the diffuser results in the diffuser being fully illuminated. In some embodiments, the diffuser is mounted in a slightly recessed portion of the light box 906. For example within a channel at the top portion of the light box 906.

FIG. 21 illustrates a schematic diagram of an example controller for a multi-layered display. The controller includes a power source 2100, processor 2102, communication device 2104, memory 2106 and NFC chip 2108.

The power source 2100 may the same power source used for the light source. In some embodiments, the power source includes a connection to a wall outlet. In some embodiments, the power source is a battery or a plurality of batteries.

The memory stores instructions which when executed by the processor cause the power source 2100 to perform the features disclosed herein. In some examples, the controller is configured to received wireless signals at the communication device 2104. These signals may be sent from a remote controller, a customer computing device, or other computing device. In some embodiments, the wireless signals include instructions for turning on or off a connected light source and/or for diming the light source.

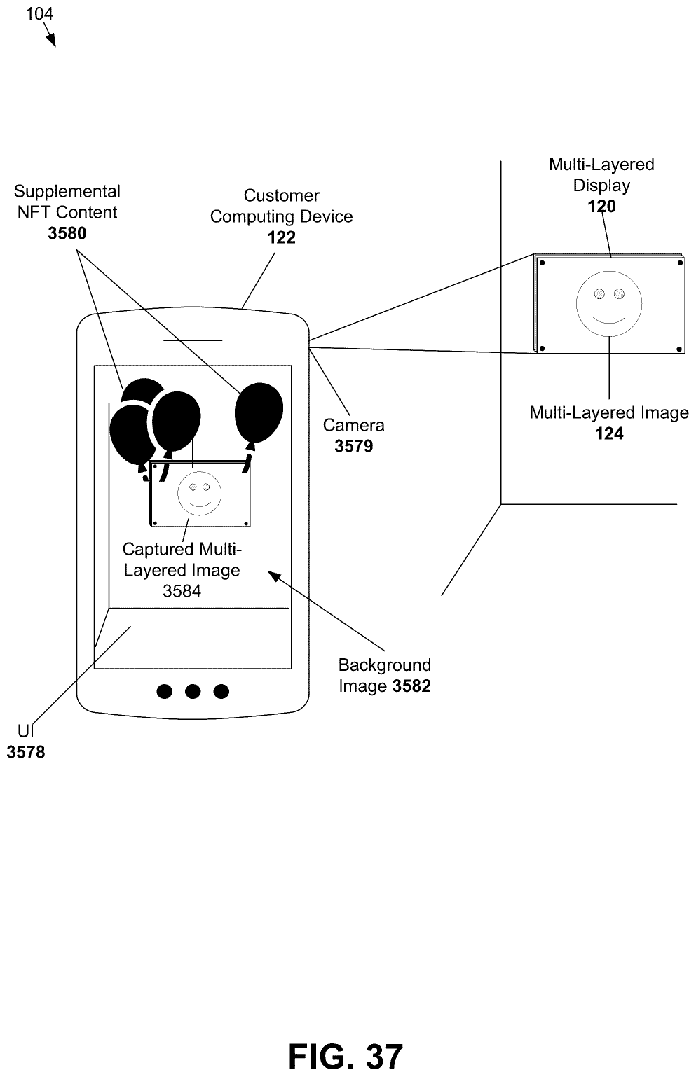

The NFC chip 2108 can be scanned by compatible near-by computing devices. In some embodiments, the NFC chip when scanned launches an application to view supplemental NFT information. For example as illustrate and describe din reference to FIG. 37. In some embodiments, the NFC chip is scanned to pair a computing device to the controller.

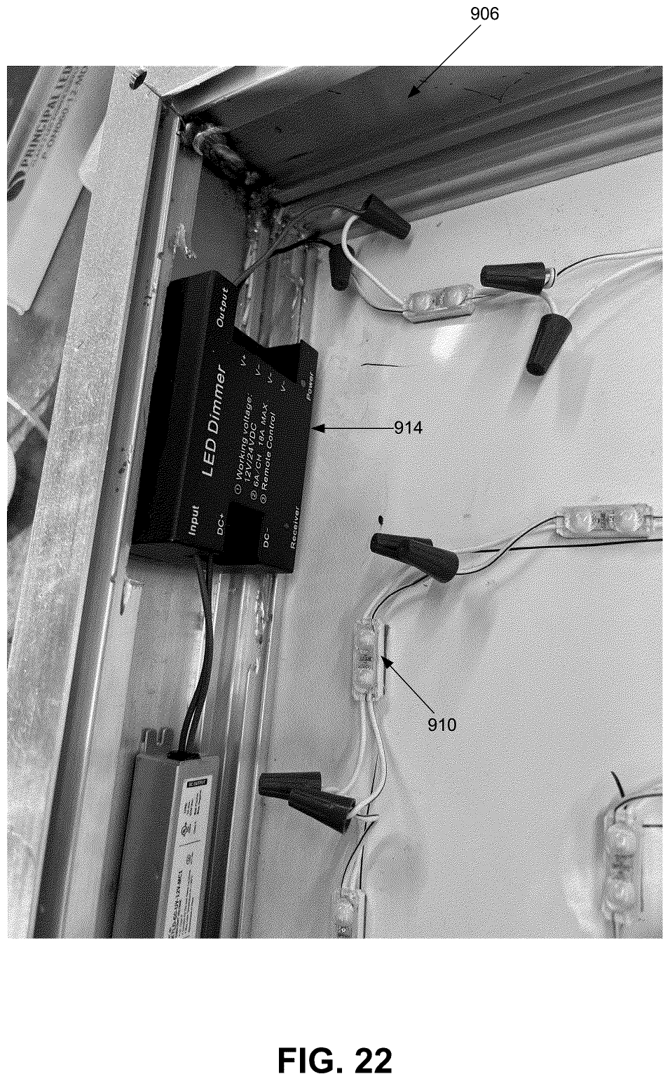

FIG. 22 illustrates a controller 914 mounted to the light box 906 of a multi-layered display. FIG. 22 is a closer perspective of the example light box 906 illustrated and described in reference to FIG. 20. In the example shown, the controller 914 is mounted on a side wall of the light box such that the controller 914 does not interfere with light emitted from the light source 910.

FIG. 23 illustrates a cross section view of an example multi-layered display 2300. The multi-layered display includes the panels 2302. The panels 2302 are similar to the panels 902 illustrated and described in reference to FIG. 9. The multi-layered display 2300 includes a LED panel 2304 which is connected to a power source 2306. The LED panel is configured to illuminate the multi-layered display 2300 from the back of the multi-layered display 2300. In some embodiments, the LED panel 2304 interfaces with a controller or physical controls to turn on or off the LED panel or otherwise adjust the light emitted from the LED panel (e.g., using a dimmer).

The panels 2302 include images applied to create a multi-layered image. E.g. as shown by the panels 11A-E in FIG. 11.

In typical embodiments, the power source 2306 is connected to a wall outlet. In other embodiments, the power source includes one or more batteries.

The multi-layered display 2300 is enclosed by side panels 2308 on each side of the multi-layered display. The side panels include grooves configured to receive and hold the panels 2302. In some embodiments, the groves are formed to match the thickness of the panel to allow the panel to slide into place while remaining secure in the groove (e.g., without wobbling etc.). An example illustrating the construction of the multi-layered display is illustrated in FIGS. 25A and 25B. The back of the multi-layered display is enclosed by a back panel that holds the LED panel 2304.

In some embodiments, the side panels 2308 and/or the back panel are made of a clear acrylic material. In some embodiments, some or all of the side panels 2308 and/or back panel 2310 are made form a wood or metal material.

In some embodiments, the panels 2302 are made from a clear material such as a clear acrylic, clear, glass, or polycarbonate. In some embodiments, the panels are an eight of an inch thick. Other thickness can also be used.

In some embodiments, the multi-layered display 2300 is geo tagged. In some embodiments, the multi-layered display 2300 includes an NFC chip. The NFC chip may be scanned to launch and augmented reality content presenting supplemental NFT content. For example, as illustrated in FIG. 37. In some embodiments, the multi-layered display 2300 is 10 inches by 10 inches by 2.875 inches. In some embodiments, the multi-layered display 2300 is 24 inches by 24 inches by 2.875 inches. The multi-layered display 2300 can be other dimensions or shapes.

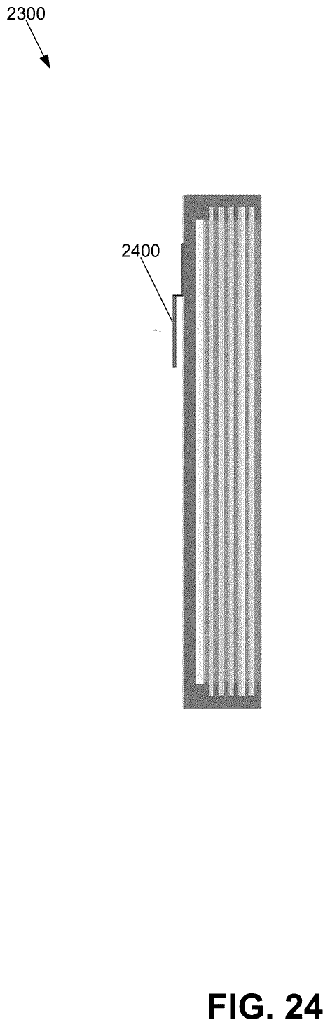

FIG. 24 illustrates another cross section view of an example multi-layered display 2300. Also shown in FIG. 24 is a wall mount 2400. The wall mount 2400 is configured to attach the multi-layered display 2300 to a wall. In some embodiments, the wall mount 2400 is a french cleat. In other embodiments, a standard mount is used. For example, a mount used for a TV or monitor, etc. In some embodiments, the wall mount 2400 is optional and the multi-layered display 2300 is configured to stand up on a flat surface. The example shown in FIG. 24 includes the same components illustrated and described in reference to FIG. 23.

FIG. 25A illustrates an example of a deconstructed box of a multi-layered display 2300. The example shown includes 4 side panels 2308 each with grooves 2498 for enclosing the panels 2302. Also shown is the back panel 2310. The back panel 2310 includes a hole 2500 allow a cord to access the LED panel 2304.

FIG. 25B illustrates a semi-constructed multi-layered display 2300. In the example shown, the side panels 2308 are constructed holding the panels 2302 with the back panel holding the LED panel 2304. A final side panel 2308 is configured to join with the two adjacent side panels 2308 to complete the construction of the multi-layered display 2300.

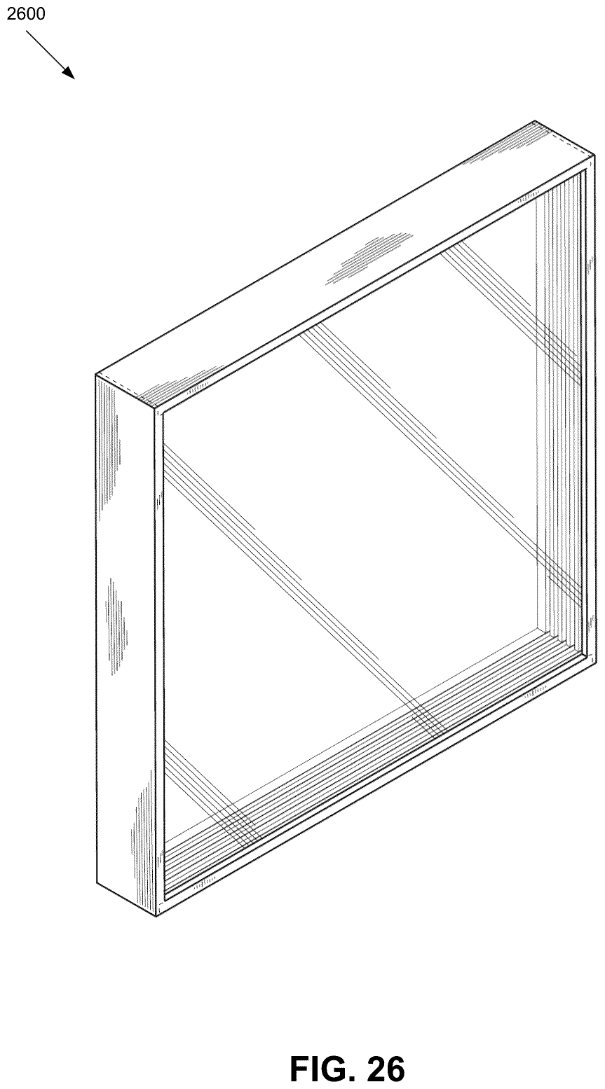

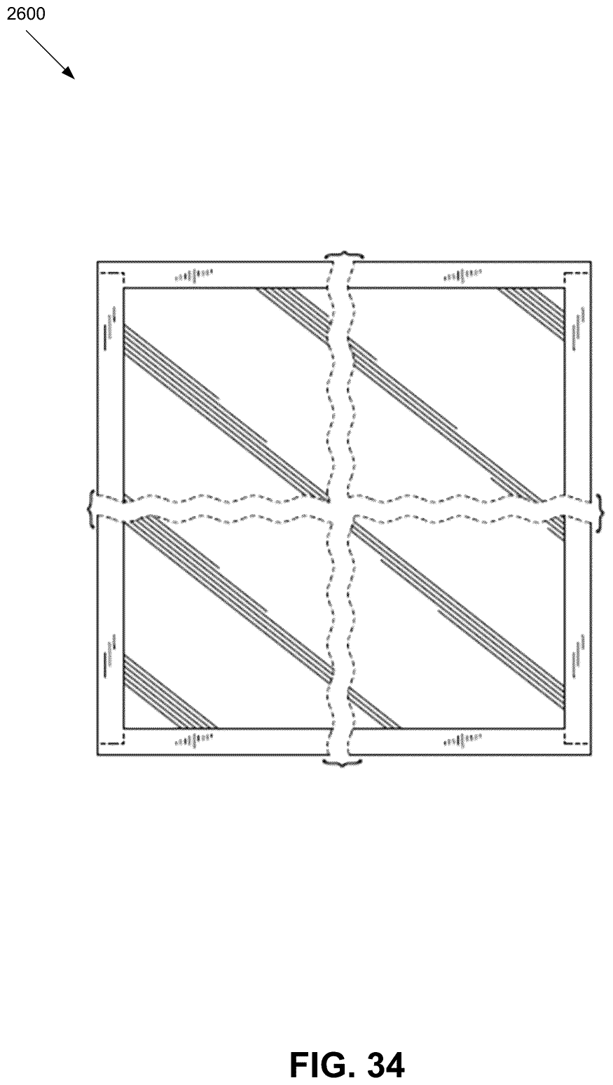

FIGS. 26 through 33 illustrate an example multi-layered display 2600 from different perspectives. FIG. 34 illustrates the example multi-layered display 2600 further exemplifying that the multi-layered display may be of different dimensions. Although the examples illustrated herein include panels in a rectangular or square shape, the panels can be of a wide variety of shapes including circular, oval, or the shape of an element in the multi-layered image (e.g., a shape of a character or environmental element, such as a tree or cloud). In some embodiments, the light panel is a square or rectangle shape with the light a material blocking the light blocked from the areas outside the boundaries of the shaped panels. In other embodiments, the light panel matches the shape of the panels. In some embodiments, the multi-layered display 2600 includes the same or similar features as the multi-layered display 2300 illustrated in FIGS. 23-25B.

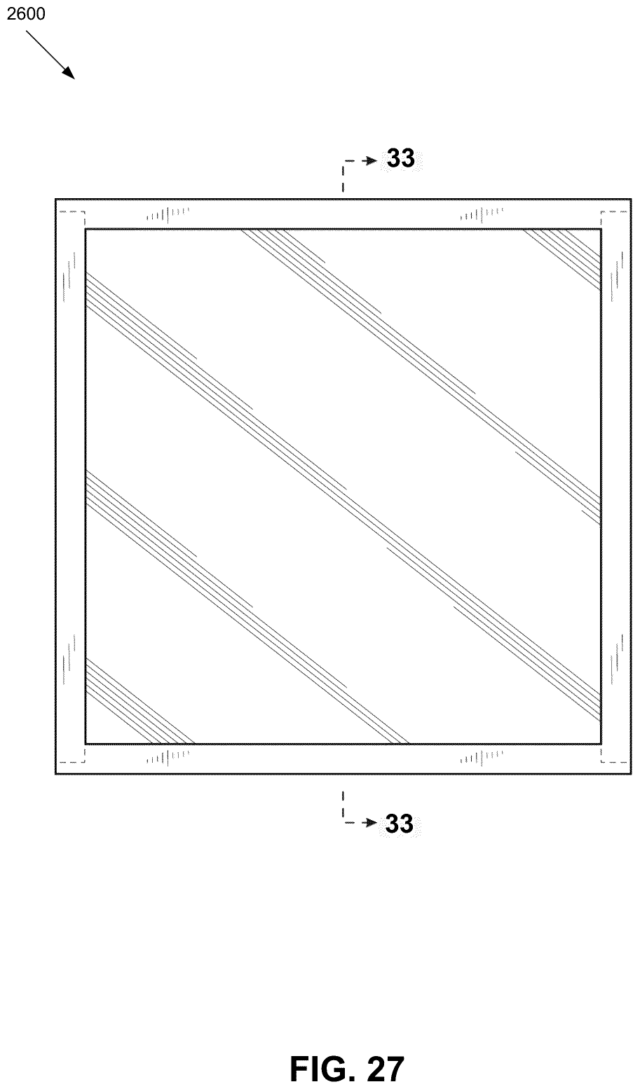

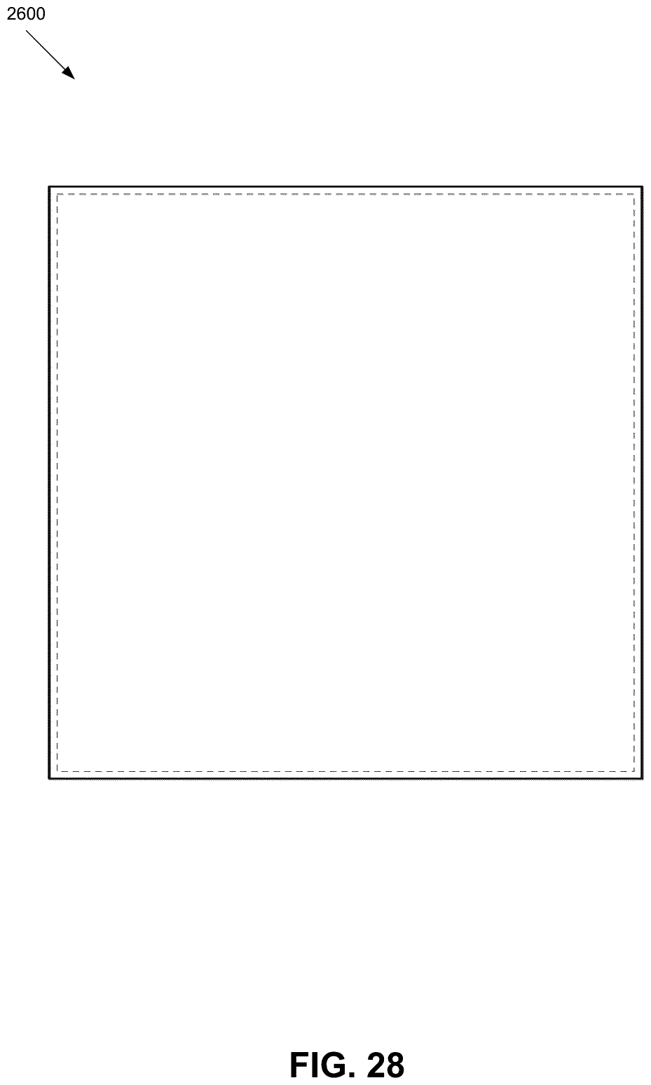

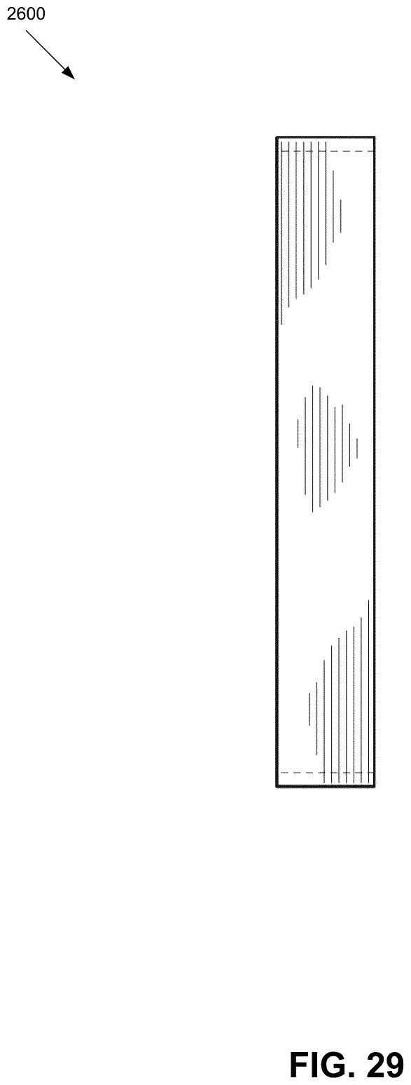

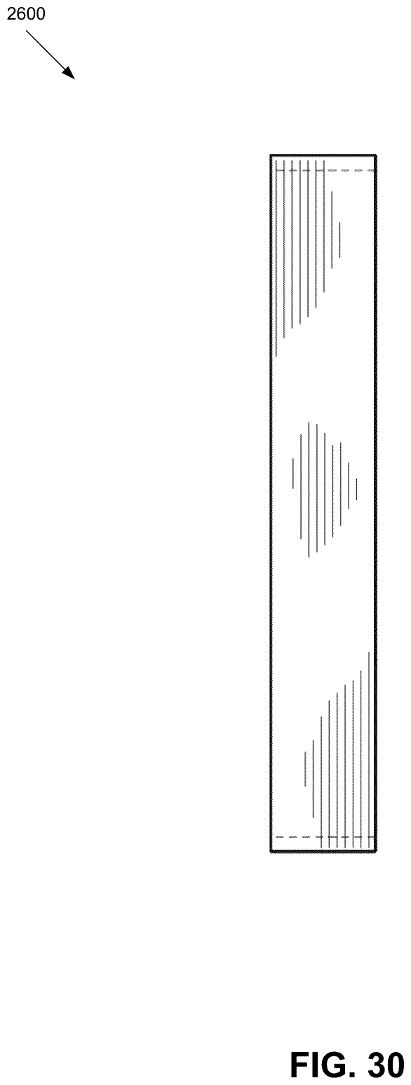

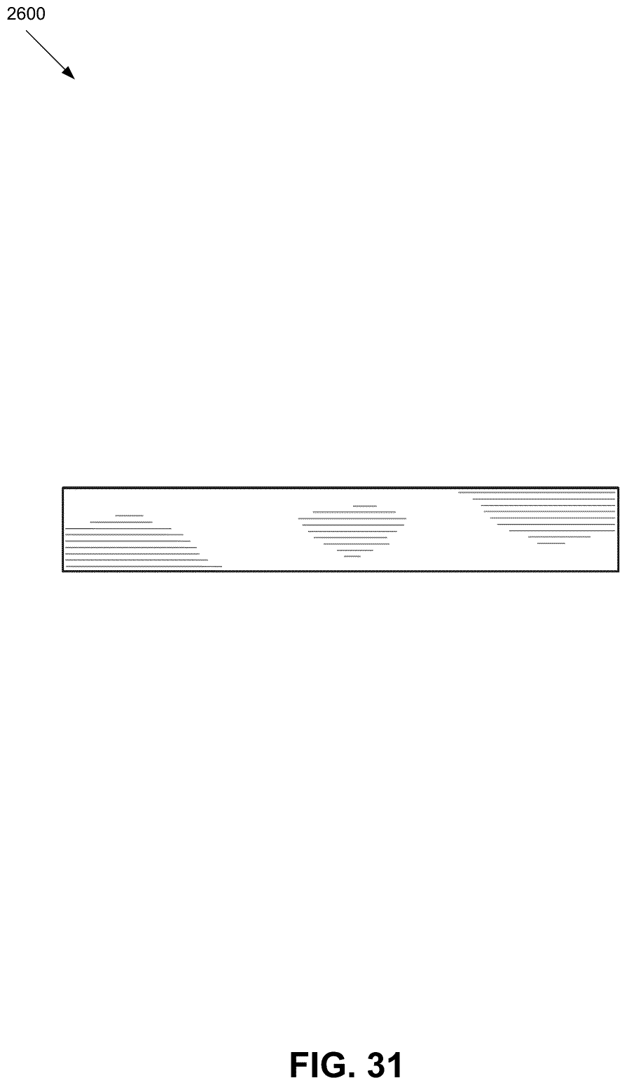

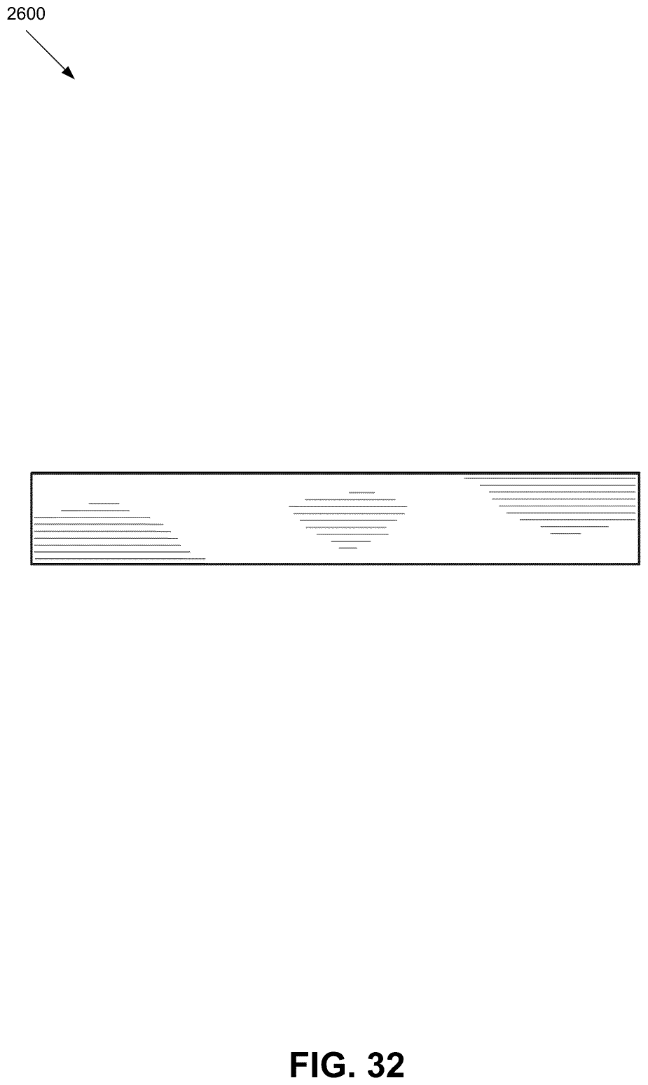

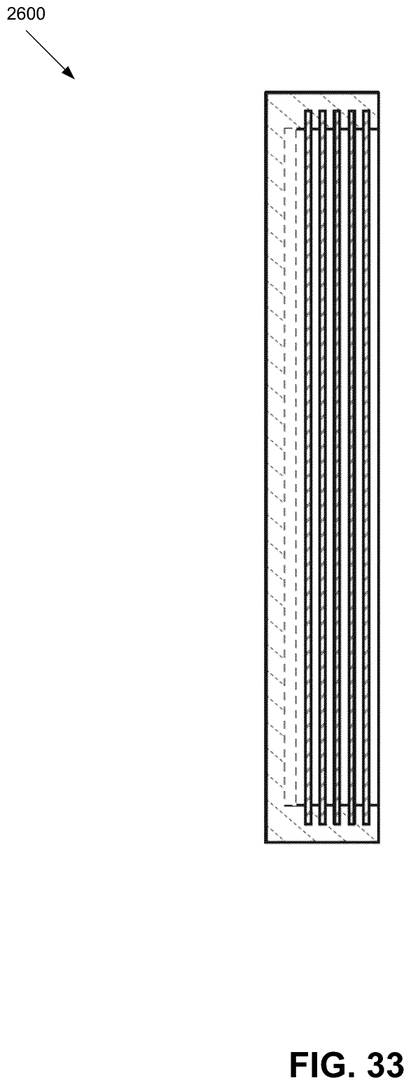

FIG. 26 illustrates a perspective view of a multi-layered display 2600. FIG. 27 illustrates the multi-layered display 2600 of FIG. 26 from a front side perspective. FIG. 28 illustrates the multi-layered display 2600 of FIG. 26 from a back side perspective. FIG. 29 illustrates the multi-layered display 2600 of FIG. 26 from a right side perspective. FIG. 30 illustrates the multi-layered display 2600 of FIG. 26 from a left side perspective. FIG. 31 illustrates the multi-layered display 2600 of FIG. 26 from a top side perspective. FIG. 32 illustrates the multi-layered display 2600 of FIG. 26 from a bottom side perspective. FIG. 33 illustrates the multi-layered display 2600 of FIG. 26 from a cross section perspective.

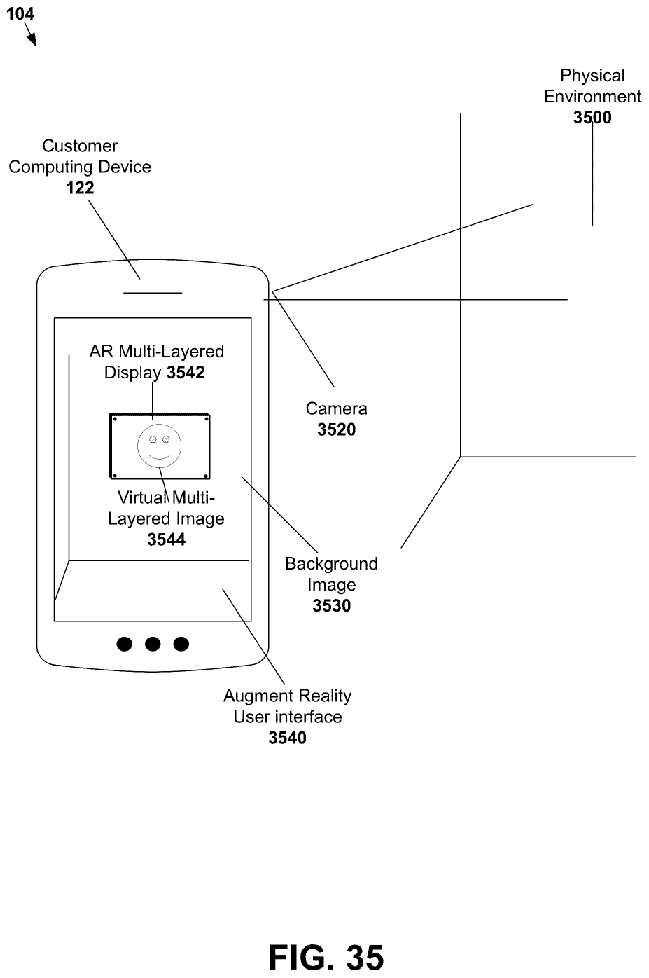

FIG. 34 illustrates an example multi-layered display 2600. In the example of FIG. 35 the area represented between the dashed wavy lines are break lines. The area between these break lines lines do not form the multi-layered display and provided to illustrate that the multi-layered display 2600 may be of a wide variety of different dimensions. As described above, the multi-layered display 2600 may be formed in many different shapes.

FIG. 35 illustrates an example of a multi-layered display in an augmented reality (AR) environment. FIG. 35 illustrates another example of the customer environment 104 illustrated and described in reference to FIG. 1. The customer environment 104 includes a customer computing device 122 and a physical environment 3500. The customer computing device includes a camera 3520 which scans the physical environment 3500 to capture a background image 3530. The background image 3530 is displayed with an augmented reality multi-layered display 3542 overlayed on the augmented reality (AR) user interface 3540. The augmented reality multi-layered display 3542 includes a virtual multi-layered image 3544. In some embodiments, the AR multi-layered display 3542 is overlayed on the background image 3530 such that the AR multi-layered display 3542 appears to be mounted to a wall or other surface. In some embodiments, a customer user utilizes the AR user interface 3540 as part of an online shopping experience for a physical multi-layered display. For example, a customer user can view a model of a multi-layered display in AR to see how different sizes or types of multi-layered display would look in a physical location.

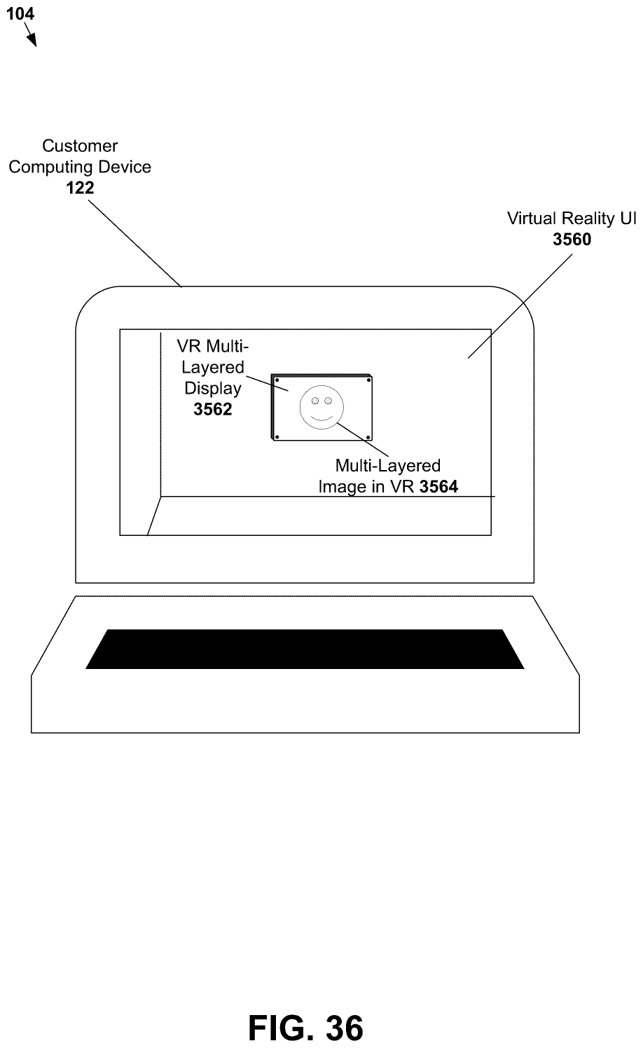

FIG. 36 illustrates an example of a multi-layered display in a virtual reality (VR) environment. FIG. 36 illustrates another example of the customer environment 104 illustrated and described in reference to FIG. 1. The customer environment 104 includes a customer computing device 122. The customer computing device 122 is executing a virtual reality application that displays the virtual reality (VR) UI 3560. The VR UI presents the VR multi-layered display 3562 in a virtual scene. The VR multi-layered display 3562 can be a 3D digital model of any of the multi-layered displays disclosed herein. In the example shown the VR multi-layered display 3562 is presented a virtual multi-layered image 3564. In some embodiments, a customer user can display the VR multi-layered display 3562 in a virtual world context. In some embodiments, the VR multi-layered display 3562 is a digital twin to a physical multi-layered display owned by the customer user. In some embodiments, the VR application is included as part of a shopping experience so a user can view a virtual model of a multi-layered display in a 3D environment before purchasing the physical multi-layered display.

FIG. 37 illustrates an example of a user interface 3578 displaying supplemental NFT content 3580 in AR. FIG. 37 is another example of the customer environment 104 illustrated and described in reference to FIG. 1. The customer environment 104 includes a customer computing device 122 and a multi-layered display 120. In some embodiments, the customer computing device 122 scans the multi-layered display 120 and displays a background image 3582 with the captured multi-layered display 3584. The supplemental NFT content 3580 is overlayed on top of the background image 3582. In some embodiments, the supplemental NFT content 3580 includes features of the digital file associated with the NFT which could not be transferred the multi-layered display. For example, if the digital file includes animated video content, the animated video content is overlayed in VR on top of or around the captured multi-layered display 3584. In some embodiments, the supplemental NFT content 3580 includes information from the NFT exchange the associated NFT is listed on. In some embodiments, the supplemental NFT content 3580 is triggered by the user scanning an NFC chip located on the multi-layered display 120. In some embodiments, a machine vision algorithm detects the NFT based on the image captured by the camera 3579 during the scan of the multi-layered display.

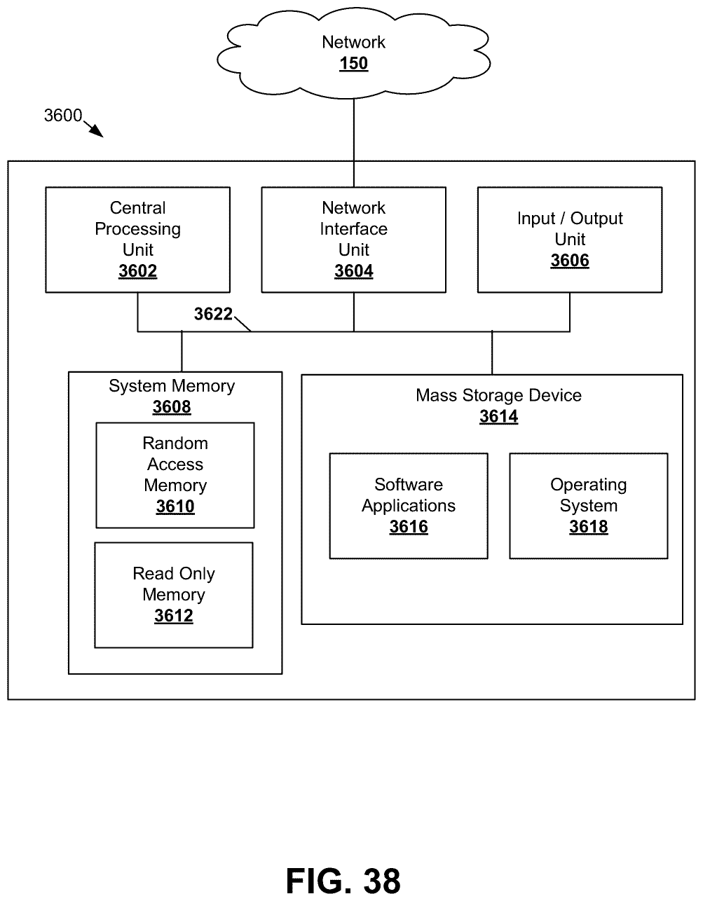

FIG. 38 is a block diagram illustrating an example of the physical components of a computing device 3600. The computing device 3600 could be implemented in various aspects of the environment 100, such as the customer computing device 122 illustrated and described in reference to FIG. 1. Components of the computing device 3600 can also be incorporated into other devices and systems described herein, such as the blockchain management server 110, the producer webserver 130, or the blockchain validators 113.

In the example shown in FIG. 38, the computing device 3600 includes at least one central processing unit (“CPU”) 3602, a system memory 3608, and a system bus 3622 that couples the system memory 3608 to the CPU 3602. The system memory 3608 includes a random access memory (“RAM”) 3610 and a read-only memory (“ROM”) 3612. A basic input/output system that contains the basic routines that help to transfer information between elements within the computing device 3600, such as during startup, is stored in the ROM 3612. The computing device 3600 further includes a mass storage device 3614. The mass storage device 3614 is able to store software instructions and data.

The mass storage device 3614 is connected to the CPU 3602 through a mass storage controller (not shown) connected to the system bus 3622. The mass storage device 3614 and its associated computer-readable storage media provide non-volatile, non-transitory data storage for the computing device 3600. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 3602 can read data and/or instructions. In certain embodiments, the computer-readable storage media comprises entirely non-transitory media.

Computer-readable storage media includes volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 3600.

According to various embodiments, the computing device 3600 can operate in a networked environment using logical connections to remote network devices through a communication network 150, such as a wireless network, the Internet, or another type of network. The computing device 3600 may connect to the communication network 150 through a network interface unit 3604 connected to the system bus 3622. It should be appreciated that the network interface unit 3604 may also be utilized to connect to other types of networks and remote computing systems. The computing device 3600 also includes an input/output controller 3606 for receiving and processing input from a number of other devices, including a touch user interface display screen, or another type of input device. Similarly, the input/output controller 3606 may provide output to a touch user interface display screen or other type of output device.

As mentioned briefly above, the mass storage device 3614 and the RAM 3610 of the computing device 3600 can store software instructions and data. The software instructions include an operating system 3618 suitable for controlling the operation of the computing device 3600. The mass storage device 3614 and/or the RAM 3610 also store software instructions, that when executed by the CPU 3602, cause the computing device 3600 to provide the functionality discussed in this document.

Aspects of the present description may also be described by the embodiments that follow. The features or combination of features disclosed in the following discussion may also be included in any of the other embodiments disclosed elsewhere herein.

Although various embodiments are described herein, those of ordinary skill in the art will understand that many modifications may be made thereto within the scope of the present disclosure. Accordingly, it is not intended that the scope of the disclosure in any way be limited by the examples provided.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A method for producing a multi-layered display, the method comprising:
receiving an order for a multi-layered display, the order including an identifier for a non-fungible token;
receiving a digital file associated with the non-fungible token;
generating a multi-layered image from the digital file associated with the non-fungible token;
applying the multi-layered image on two or more panels; and
producing the multi-layered display with the two or more panels.

2. The method of claim 1, wherein the order for a multi-layered display is received form a customer computing device.

3. The method of claim 1, wherein the identifier for the non-fungible token includes a link to an online non-fungible token marketplace.

4. The method of claim 1, wherein the identifier for the non-fungible token is received by connecting a customer non-fungible token wallet.

5. The method of claim 1, the method further comprising:
verifying rights to use the digital file associated with the non-fungible token.

6. The method of claim 5, wherein verifying rights to use the digital file includes at least one of:
(a) verifying a customer user requesting the order has an ownership right in the digital file based at least in part on the non-fungible token;
(b) verifying the customer user requesting the order has rights to reproduce the digital file based at least in part on the non-fungible token; or
(c) any combination of (a) and (b).

7. The method of claim 5, wherein the verification is performed at least in part by accessing a blockchain that the non-fungible token is recorded on.

8. The method of claim 1, wherein generating a multi-layered image from the digital file associated with the non-fungible token further comprises:
determining a file type of the digital file;
converting the digital file into a high resolution image based at least in part on the file type; and
generate the multi-layered image from the high resolution image.

9. The method of claim 8, wherein the file type is one of:
(a) jpeg;
(b) png;
(c) GIF;
(d) MP4;
(e) FVG;
(f) WEBM;
(g) WAV;
(h) OGG;
(i) CLBG; or
(j) GTLF.

10. The method of claim 1, wherein generating the multi-layered image from the digital file associated with the non-fungible token is performed automatically using artificial intelligence.

11. The method of claim 1, wherein applying the multi-layered image on two or more panels includes printing the multi-layered image on the two more panels.

12. The method of claim 1, wherein applying the multi-layer image further includes printing the multi-layered image on two or more vinyl layers and adhering the two or more vinyl layers to the two or more panels.

13. A multi-layered display comprising:
a light source;
two or more panels including a multi-layered image generated from a digital file associated with a non-fungible token; and
a controller comprising a processor, a communication device, and a memory, wherein the controller is configured to control the light source via commands received at the communication device,
wherein the one or more panels are aligned with the light source.

14. The multi-layered display of claim 15, wherein the two or more panels are acrylic panels.

15. The multi-layered display of claim 15, wherein the light source comprises a light box containing a plurality of LEDs fixed to a backend on an interior side of the light box, wherein a front end of the light box at least partially includes an occluded panel.

16. The multi-layered display of claim 15, wherein the multi-layered display forms a box with an LED panel positioned at a back end of the box.

17. The multi-layered display of claim 15, further comprising a near-field communication chip, which when scanned and selected at a computing device, displays supplemental content related to the non-fungible token on the computing device in augmented reality.

18. A producer webserver, comprising:
a network interface device;
at least one processor;
at least one memory device storing instructions which, when executed causes the producer webserver to:
provide a shopping user interface to a customer user computing device in response to receiving a request from the customer user computing device;
receive an order for a multi-layered display from the customer user computing device, the order including an identifier for a non-fungible token; and
generating a multi-layered image from a digital file associated with the non-fungible token;
wherein the multi-layered display is produced by applying the multi-layered image on two or more panels.

19. The produce webserver of claim 18, wherein the multi-layered display is a virtual object which is presented in at least one of:
(a) virtual reality;
(b) augmented reality; or
(c) any combination of (a) and (b).

20. The produce webserver of claim 18, wherein the digital file associated with the non-fungible token is automatically downloaded in response to receiving the order.
